(19) United States
(12) Patent Application Publication
(10) Pub. No.: US 2002/0178034 A1
(43) Pub. Date: Nov. 28, 2002

(54) AIRLINE TRAVEL TECHNOLOGIES

(76) Inventors: CHRISTOPHER W. GARDNER, MINNEAPOLIS, MN (US); GREGORY C. DENNIS, SHAKOPEE, MN (US)

Correspondence Address: MERCHANT & GOULD PC, P.O. BOX 2903, MINNEAPOLIS, MN, 55402-0903, US

(21) Appl. No.: 09/435,387

(22) Filed: Nov. 5, 1999

Related U.S. Application Data
(63) Continuation of application No. 09/172,317, filed on Oct. 14, 1998, now abandoned.
Application No. 09/172,317 is a continuation of application No. 08/633,849, filed on Apr. 10, 1996, now abandoned.

(51) Int. Cl. G06F 17/60

(52) U.S. Cl. 705/5

(57) ABSTRACT

A method for reducing the costs and enhancing revenue controls associated with airline travel distribution. The method combines a sales transaction and a usage transaction into one centralized transaction. Thus, the each sales transaction represents a usage transaction. Furthermore, the method eliminates the advanced issuance of an accountable and specific travel authorization. The present invention also discloses a system for reducing the costs and enhancing revenue controls associated with airline travel distribution. The system includes a bill per use module that combines each sales transaction with a corresponding usage transaction into one centralized transaction. Accordingly, each sales transaction represents a usage transaction. Thus, the bill per use module eliminates the advanced issuance of an accountable and specific travel authorization.

### REFERENCE TO CO-PENDING APPLICATIONS

This application claims priority to U.S. patent application Ser. No. 09/172,317, filed Oct. 14, 1998, which is a continuation of U.S. patent application Ser. No. 08/633,849, filed Apr. 10, 1996, the disclosures for both of which are hereby incorporated by reference.

### TECHNICAL FIELD

The present invention is directed to information systems, and more particularly to an information system for automating distribution of travel products, such as airline tickets.

### BACKGROUND

There have been many approaches to distributing services related to the travel industry. These approaches, however, typically have been fragmented and labor intensive. For example, many existing airline travel distribution systems manage several separate events when processing an airline reservation. From a passenger's perspective, these events may include the initial booking, issuance of a ticket/commitment to purchase the ticket, changes to the travel itinerary, reissuance/exchange of the ticket, issuance of the boarding authorization, or issuance of a refund. To ensure the integrity and accuracy of the overall transaction, the system processing the reservation must reconcile each of these events at various points along the life cycle of a transaction. As a result, the total processing required to process a transaction lead to a very inefficient and therefore expensive way to provide this service.

Many existing airline travel distribution systems following this event cycle necessarily involve redundant processing and as a result are extremely inefficient. For example, such systems typically rely on a “bill at time of sale” approach to manage the booking and ticket issuance events. Under this approach, the customer typically purchases an entitlement to travel (i.e. a ticket) based on a specified itinerary with reserved seats. The customer ordinarily then would submit coupons from the ticket to the airline as travel is redeemed. The consequence of billing at the time of sale requires the complex administration of issuing/distributing tickets (paper or electronic) and then collecting and reconciling them.

By creating a time lag between sale and use, various non-value added transactions and substantial exposure to revenue dilution are created. For example, when a customer changes their itinerary after the sale but before use of the ticket, a refund/exchange transaction may be required to reconcile the overall transaction. Moreover, if a reissue or exchange is required, the value of the original ticket must be appropriately assessed and applied to the new or updated itinerary. Thus, if the prices differ, the customer is required to pay additional fare or a refund may be due. Furthermore, at the time of boarding or usage, an agent must assess whether the ticket flight coupon is valid for the new flight. In many existing systems, these transactions account for 25% of all sales transactions and results in considerable expense to the airline.

The “bill at time of sale” approach also exposes airline companies to additional revenue dilution problems such as “hidden city” and “throw-away” ticketing practices. These practices typically involve the customers knowingly purchasing round trip tickets or travel itineraries with connecting flights without ever using the second segment of the flight. As a result, the user can avoid the higher priced one-way ticket price or the direct ticket price to a smaller, more expensive city. These transactions can severely undermine an airline's profitability.

In conjunction with “sale before use,” tickets (both paper and electronic) must be issued for travel. For paper tickets these accountable documents must be printed and delivered to the customer prior to travel. For electronic tickets, these accountable records must be issued to a central database, and distributed access must be provided to numerous locations through proprietary networks. By definition, both accountable documents and accountable records require financial reconciliation and controls to track unearned revenue liabilities and reduce fraud exposure.

Another important side effect of today's advance ticketing paradigm is that it complicates an airline's ability to enforce revenue management principles. When a ticket is issued, the pricing and revenue management principles are applied in the pricing and itinerary definition. Assuming correct issuance, these principles are only effective if the ticket is properly used.

Subsequent verification and reconciliation of the ticket often require more pricing knowledge than airline personnel may have or more scrutiny than time permits. The result is that improper usage occurs and change/penalty fees are under collected. When this loophole becomes a common expectation, revenue dilution typically occurs.

Another practice of increasing popularity which causes revenue dilution is ‘hidden city’ ticketing. The advanced issuance of tickets makes this and other coupon “throw-away” situations possible and very difficult if not impossible to combat. The result is that an airline must often make a difficult decision between being noncompetitive in a market with respect to price or diluting revenue in a related market.

The problem of a traveler not using a ticket as planned is not only an airline problem that dilutes revenue. It is also a corporation's problem in controlling cost and travel policy. Since a ticket can be as good as cash for travel and a corporation has no way to reconcile ticket issuance against usage, a corporation has no control over illicit travel. For example, how many travel managers can answer the question: How many authorized tickets have been issued but not properly used or refunded?

Today, customers typically deal with all tickets purchased but not used. This typically requires customers (or their assistants) to file for refunds for unused flight coupons, fare adjustments after ticket issuance, and lost tickets. Worse, customers often have to exchange tickets at travel agencies or airport counters at the last minute. Exchanging tickets at an airport counter can be a very time consuming proposition, not only for the customer exchanging the ticket but also for those in line behind the customer. Electronic Ticketing eliminates the requirement of conducting the transaction at a particular locale, but does add the requirement of conducting a live conversation with a customer service representative (e.g. cannot simply hand ticket to someone else to handle). Fast Track Travel eliminates all customer hassles with refunds and exchanges. By billing at time of boarding, the customer is never billed more than the service received.

The inefficiencies associated with many existing systems is further exacerbated because after usage is captured, the airline must match the usage to the sale to recognize earned revenue. If the usage is different than the sale, reconciliation may be required for financial accounting purposes. If the ticket is not completely used or a qualifying discount was not applied at time of issuance, the airline may have to process a refund at the request of the customer.

The main culprit of this avoidable work is that an accountable and specific travel authorization is being issued in advance. The travel authorization (i.e. paper or electronic ticket) is accountable in that it has monetary value which is potentially transferable and is specific in that it applies to a discrete itinerary (i.e. it may not apply to a different itinerary). The accountable and specific nature of tickets require them to be repeatedly verified and reconciled throughout their transaction life cycle until complete usage occurs.

Another problem with existing systems relates to the bookings/reservation process. Today, the average phone wait for an airline's reservation agent can varies from 1-3 minutes per call. This does not include customers who get busy signals or hang-up before getting an agent. During busy fare promotions the average wait can become prohibitive for the time sensitive business traveler. Current electronic ticketing initiatives can actually increase the reliance of customers on traditional reservation agents and manual phone lines.

No system currently exists that is capable of operating with one or more airline partners to provide an easy and efficient means of automatically distributing travel services, such as airline travel. While many existing systems manage and control travel distribution transactions, none of the current systems provides an end-to-end product focus or impact. Travel customers need easier and more efficient ways to arrange and secure their travel plans. Likewise, airline companies would benefit from a system that maximizes processing efficiency resulting in greater profitability and also improving the overall value delivered to their customers. An information system is needed wherein travel services are efficiently distributed and are tailored to meet the o specific needs of both travel customers and airline corporations.

### SUMMARY

Generally, the present invention relates to a method for reducing the costs and enhancing revenue controls associated with airline travel distribution. The method combines a sales transaction and a usage transaction into one centralized transaction. Thus, the each sales transaction represents a usage transaction. Furthermore, the method eliminates the advanced issuance of an accountable and specific travel authorization.

The present invention also relates to a system for reducing the costs and enhancing revenue controls associated with airline travel distribution. The system includes a bill per use module that combines each sales transaction with a corresponding usage transaction into one centralized transaction. Accordingly, each sales transaction represents a usage transaction. Thus, the bill per use module eliminates the advanced issuance of an accountable and specific travel authorization.

These and various other features as well as advantage, which characterize the present invention, will be apparent from a reading of the following detailed description and a review of the associated drawings.

### BRIEF DESCRIPTION OF THE DRAWINGS

FIG. 1 is a high-level diagram of an automated travel system;

FIG. 2 is a high-level diagram of the various components of an automated travel system;

FIG. 3 is a diagram showing a reservation booking process;

FIG. 4a is a diagram showing a passenger reservation services process;

FIG. 4b is a diagram showing the APIs and services for a Work-in-Process UI Service;

FIG. 4c is a diagram showing the APIs and services for a Traveler Profile and Cleanup UI Service;

FIG. 4d is a diagram showing the APIs and services for a Reservation, Pricing, and Confirmation UI Service;

FIG. 4e is a diagram showing the APIs and services for a Flight Schedule UI Service;

FIG. 5 is a diagram showing the APIs and services for a Profiles Booking Support module;

FIG. 6 is a diagram showing the APIs, services and external APIs for a Flight Schedule/Availability module;

FIG. 7a is a diagram showing the APIs and services of a pricing services driver module;

FIG. 7b is a logical processing flow chart of a pricing services driver module;

FIGS. 8a-8c is a diagram showing the APIs, service drivers, and services for a master reservation API/Service;

FIG. 9 is diagram showing a the APIs and services for a travel correspondence module; and

FIG. 10 is a high-level diagram of a user interface architecture of automated travel system;

### DETAILED DESCRIPTION OF THE EMBODIMENTS

The present invention relates to an automated travel system that improves the quality of airline travel distribution products and services.

The logical operations of the various embodiments of the present invention are implemented (1) as a sequence of computer implemented steps running on a computing system and/or (2) as interconnected machine logic modules within the computing system. The implementation is a matter of choice dependent on the performance requirements of the computing system implementing the invention. Accordingly, the logical operations making up the embodiments of the present invention described herein are referred to variously as operations, steps or modules.

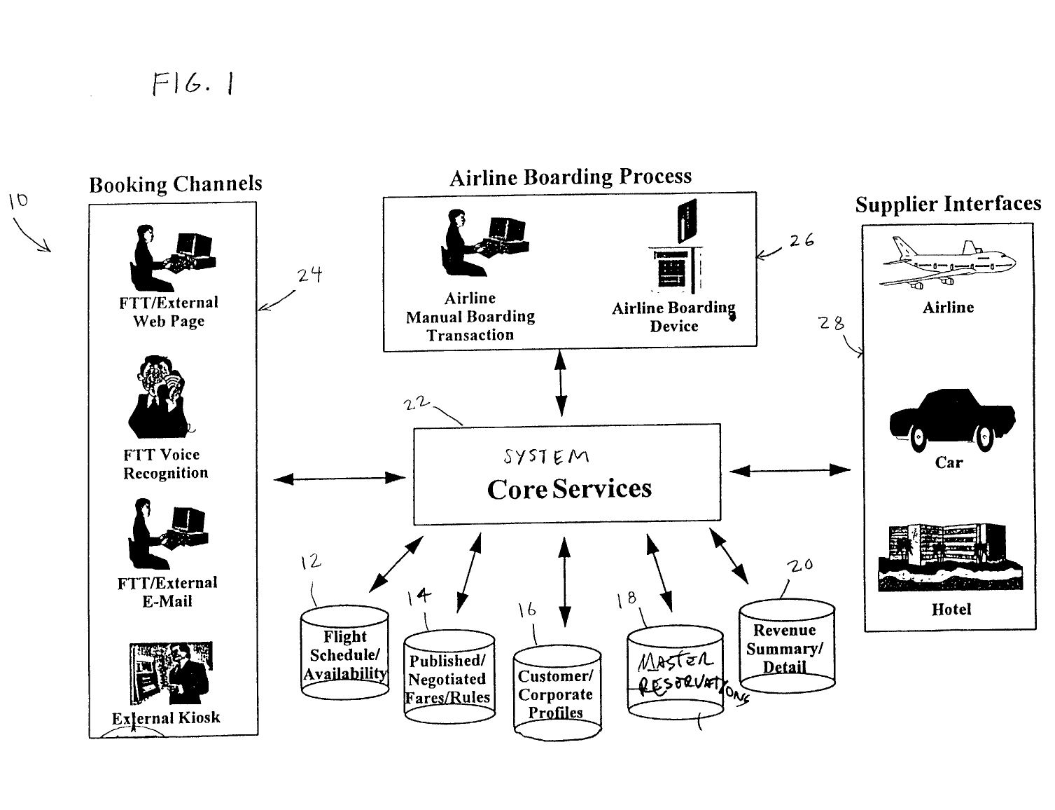

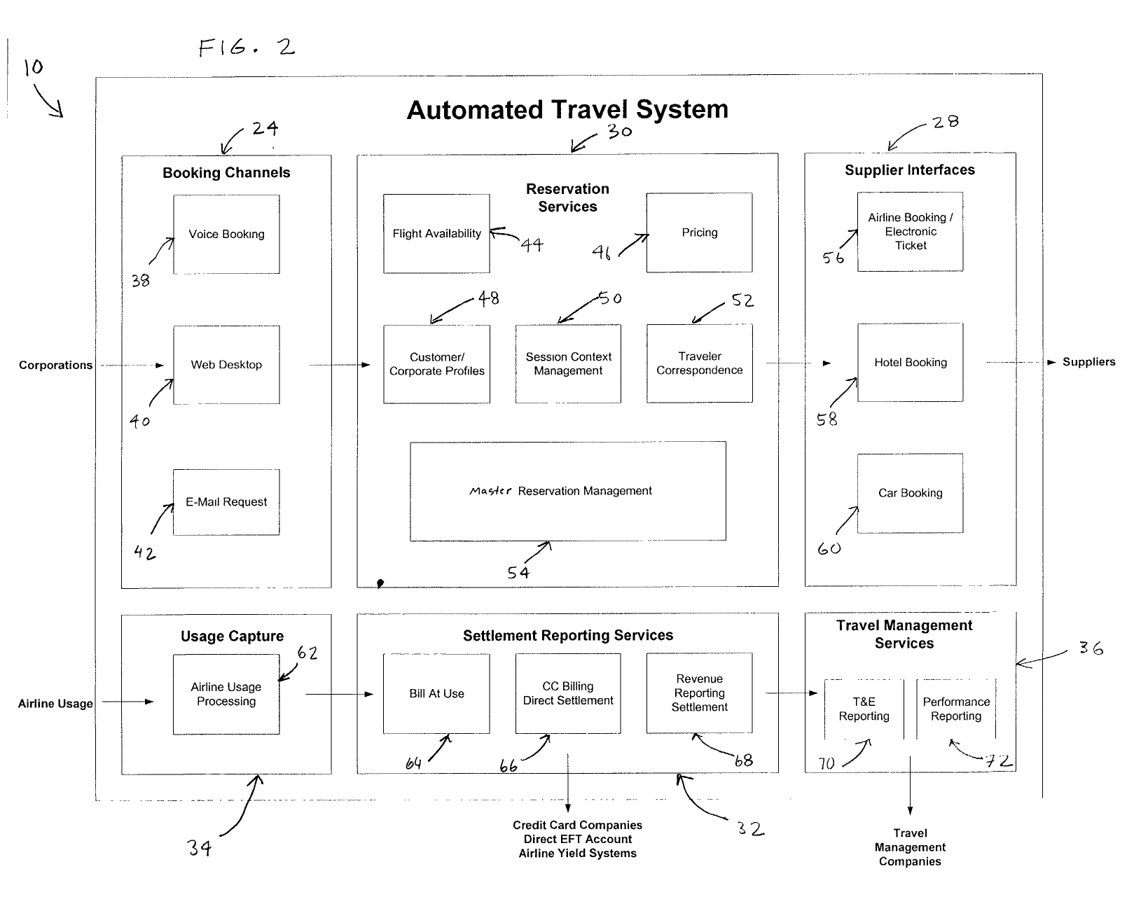

Referring now to the drawings, FIG. 1 illustrates the overall functioning of automated travel system 10 of the present invention. Automated travel system 10 is comprised of four components: system core services 22, booking channels 24, airline boarding process 26, supplier interfaces 28. These various components of automated travel system 10 will be described below with reference to FIG. 2.

System core services 22 is configured to operate with a series of databases, including flight schedule availability database 12, published negotiated fares/rules database 14, customer corporate profiles database 16, master reservations database 18, and revenue summary/detail database 20.

FIG. 2 is a more detailed illustration of automated travel system 10. In addition to the components listed above, system core services 22 further comprises reservations services 30, settlement reporting service 32 and travel management services 36. Booking channels 24 receive booking information from customers and connects by open application programming interfaces (“APIs”) to reservation services 30. Reservation services 30 provides centralized and integrated marketing at the point of sale. Furthermore, reservation services 30 also integrates mainframe computer reservation systems (“CRS”), agency, and airline revenue accounting to keep track of sales. Reservation services 30 interfaces with supplier interfaces 28 to provide information to suppliers.

Additionally, automated travel system 10 also interfaces with airline usage data suppliers through usage capture 62. Usage capture 34 processes airline usage data and interfaces with settlement/reporting services 32. The data from the settlement/reporting services 32 is configured to interface with credit card companies, Direct EFT (“electronic funds transfer”) account handling, and airline yield systems. Similarly, settlement/reporting services 32 is also configured to interface with travel management services component 36. Travel management services 36 interfaces with travel management companies and is configured to operate with the automated travel system 10 of the present invention.

As is further shown in FIG. 1, there are several booking channels 24 that receive information from a customer. Booking channels 24 are characterized as subcomponents herein. In one embodiment of the present invention, booking channels 24 comprises a voice booking system 38. Voice booking system 38 is the subject of a separate patent application (filed separately on Apr. 10, 1996, and titled “AUTOMATED BOOKING SYSTEM”, naming Jeffrey S. Klepfer as inventor), which is herein incorporated by reference. Voice booking system 38 communicates with reservation services 30, preferably through an open API.

In another embodiment of the present invention, web desktop 40 is available to travelers as an interface to reservation services 30. Web desktop 40 encompasses a traveler's personal computer system programmed and configured to operate with the World Wide Web to provide booking information via an open API to reservation services 30.

Still yet, another embodiment of the invention allows a traveler to interface with reservation services 30 using e-mail request processing 42.

It should be noted that the foregoing booking channels 24 are intended to be illustrative, but in no way limiting, as kiosk and other approaches can be used. Indeed, one difference between the present invention and the prior art is the capability of being open, rather than closed, to the means for booking.

Booking channels 24 interface with open and published API's to permit broad access to the reservation services 30. As discussed above, reservation services 30 provides centralized and integrated marketing at the point of sale. Furthermore, reservation services 30 also integrates CRS, agency, and airline revenue accounting to keep track of sales.

To carry out these activities, as illustrated in FIG. 1, there are several subcomponents of reservation services 30. The subcomponents include flight availability system 44, customer/corporate profiles 48, session context management 50, pricing system 46, traveler correspondence system 52, and master reservation management system 54.

Flight availability system 44 includes a computing system (not shown) configured to operate with and access a database (not shown). The database stores data related to OAG flight schedules for all carriers, including service and non-stop/direct flight schedules. Furthermore, the flight database includes data on flight schedules, flight legs, and flight leg details. By using flight availability system 44, a request received from one of booking channels 24 triggers identification of all possible flight connections. Accordingly, the flight information is compared with connection flight information and tested against pre-specified connection rules to determine valid connecting flights. Local flight availability is supported via AVS messages.

Customer/corporate profiles system 48 integrates customer preferences with corporate policies. Customer/corporate profiles system 48 permits customized “biasing” by corporation/customer. This feature is useful for directing point-of-service (“POS”) marketing and applying revenue controls. Additionally, there is a travel policy compliance reporting capability that uses a database that includes information specific to each corporate entity. For example, the database includes supplier preferences data (i.e. negotiated arrangements), classification/class of service verification, preferred forms of payment and internal billing codes, fare types and service levels for low fare requirements, and other corporation/customer preference information. In one embodiment of the present invention, the data in the database can be derived from a corporation and applied to its employee. Furthermore, the present invention can also consider the individual's preferences that need to be considered in addition to travel policies established by the corporation.

Session context management 50 includes maintaining user session data during a booking process and insulates interfaces from reservation process controls. Here, the voice session of booking channels 24 is transferred for handling, and CTI is transferred out to a travel agent. Automated booking context management permits automated travel system 10 to efficiently handle input of data generated in multiple booking sessions.

Pricing system 46 contacts automated travel system 10 for corporate fares. Given a scheduled itinerary provided through booking channels 24, pricing services 46 constructs prices for each possible itinerary and then tests the resulting fares to select the lowest fare. This is accomplished by means of a database including published fares, with footnotes and routings, along with automated rules for fares and corporate fare rules. Pricing services system 46 permits a low fare price search for relatively “loose” travel itineraries and affords service for “price driven” leisure travelers.

Travel correspondence system 52 provides, by computer, automated notification to a traveler/customer of critical events involving the original booking or a change in the booking. Notification can include flight cancellation, delay, changes, upgrade eligibility, re-booking, waitlist eligibility/booking, as well as other disclosure or liability information. In one embodiment of the invention, this information can be communicated using devices that include text notification, such as, e-mail and fax.

Master reservation management system 54 provides a consolidation of PNR and ticketing images, and otherwise provides complete travel information from booking to boarding. Trips are identified by a confirmation number, preferably without generating a ticket. Trip “versions” retain full trip modification histories, synchronizing old and new itineraries. Data is formatted and E-mailed or otherwise electronically communicated to an airline via an interface.

Settlement/reporting services component 32 includes three subcomponents: bill at use 64, credit card billing direct settlement subcomponent 66, and revenue reporting/settlement 68. Bill at use subcomponent 64 is a unique approach to billing that permits many efficiencies and capabilities attained by the present invention. Bill at use 64 invokes off-peak settlement processing, separates billing and revenue values, makes leg revenue values and adjustments for revenue reporting, and can handle usage capture from host airline E-ticket system. The accounting commences with a usage event, having a price itinerary as used. There is a pro-rating to a flight leg, and adjustments are communicated as necessary. The bill per use subcomponent 64 will be discussed in more detail below.

Credit card billing direct settlement subcomponent 66 processes billing on behalf of the supplier (merchant), with electronic funds transfer (EFT) for direct settlement. There is full processing of a corporate credit card program, with an available credit balance check, billing credit transactions, and detailed reporting.

Revenue reporting settlement subcomponent 68 handles receiving revenue values and adjustments from bill at use 64, and then computes revenue as PPA/R/A data File (RADF). A tax and settlement report is also generated, and a booking/revenue history trip detail is stored. A summary of the booking/revenue history is generated by corporation/customer, and other revenue summaries are prepared.

Supplier interface 28 includes three subcomponents. Airline booking/e-ticket 56 uses industry-accepted communication protocols-PADIS/EDIFACT for bookings and PNR creation; AVS for availability and booking/PNR backup. Direct airline host access for information provides outside of automated travel system 10 that includes last seat availability, seat map assignments, booking “wrap up” NPR creation and frequent traveler data. There is access to CRS only when direct airline host access is prohibited. Accordingly, airline booking/e-ticket 56 handles the inventory sales, seat assignment/map, creation of PNR, all via EDIFACT, with a link first to the host airline, and failing that, to CRS.

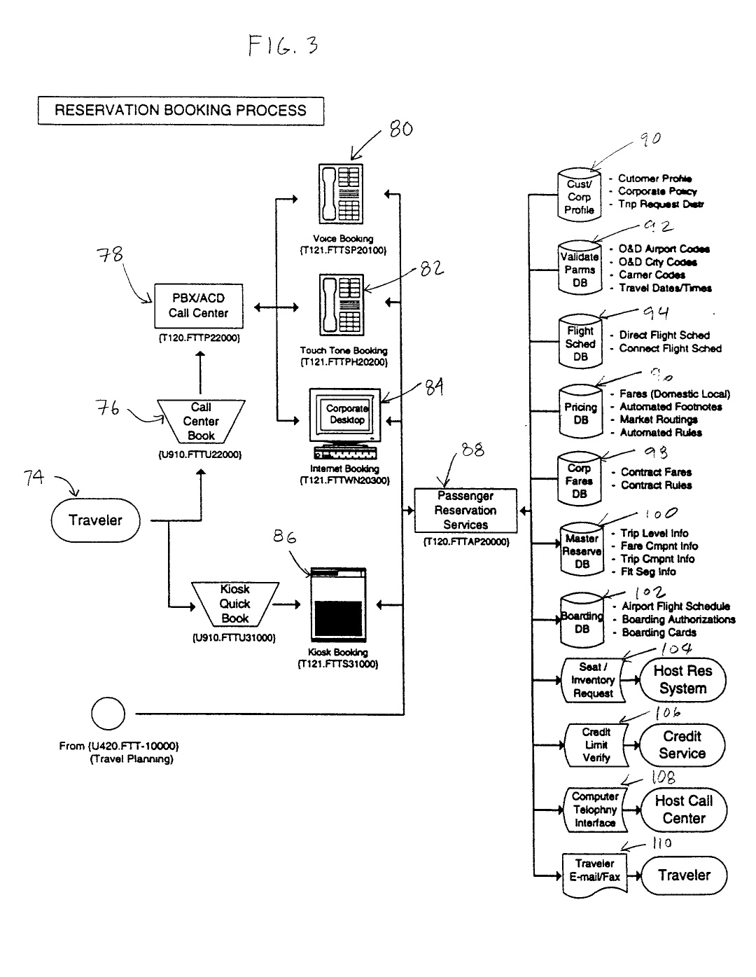

Referring now to FIG. 3, a traveler can book or change his or her reservation using a multi-platform reservation booking process. The process of booking/changing a reservation includes the specification of the traveler's desired trip information, selection of flights from viable trip options, determination of flight availability/seat assignment, lowest available pricing for the flight schedule selected, and confirmation of travel information to the passenger. Profile information at the customer and the corporate level provides facilitation at each of these stages of the booking process.

Typically, the user first accesses the reservation booking process through call center book 76. From there, the user can access a PBX/ACD call center 78. As shown in FIG. 3, PBX/ADC System 78 manages the distribution of all calls to the various booking channels, including a voice booking conversation 80, a touch-tone booking conversation (“DTMF”) 82, a corporate desktop booking conversation 84 (i.e. agent-assisted conversation), and a kiosk booking conversation 86. PBX/ADC call center 78 includes load balancing, intelligent routing/queuing, and Computer Telephone Integration (“CTI”) from the voice and touch-tone conversations by providing an index to a stored booking record of traveler context information.

The traveler can book a reservation through various user interfaces or booking channels, each provided to serve somewhat different stages of the traveler's experience. In one embodiment of the invention, a voice booking conversation 80 is provided and is used primarily when travel planning has been previously determined or need to be quickly modified due to sudden schedule changes. Similarly, digital touch tone (“DTMF”) booking conversation 82 can be used for similar reasons as the voice booking conversation. However, DTMF 82 can be used when voice is not as convenient to use.

In an alternative embodiment, a traveler can access corporate desktop Internet booking conversation 84 when travel planning requires assistance from a reservation agent particularly in involuntary travel interruption situations but also for assistance with a new booking. If the traveler requires assistance within the voice booking 80 or DTMF booking 82, context information is transferred to this conversation along with the call to the reservation agent (CTI interface). Furthermore, corporate desktop Internet booking conversation 84 communicating via a communications network, such as the Internet, can be used for primary travel planning activities as well as booking or changing a reservation.

In yet another embodiment, airport check-in kiosk conversation 86 can be used primarily when sudden schedule changes require that travel plans be modified when the traveler is at the airport.

Furthermore, as shown in FIG. 3, each of the booking channels is coupled to passenger reservation service 88 which serves as an interface between the booking channels and the data structures related to the reservation booking process. Accordingly, the automated travel system of the present invention allows travelers to access the system using any of the above described booking channels and schedule a reservation. Yet, reservation booking process is not dependent upon the method the user chooses to set his or her reservation. Thus, reservation booking process is a multi-platform system that allows users to create a reservation/itinerary and access that itinerary using any of booking channels shown in FIG. 3.

Passenger reservation services 88 acts as a single interface to the back-end services that support the booking process from any of the booking interfaces. Essentially, this process ensures that all the necessary steps to complete a booking have been properly performed before confirmation of the reservation can be provided to the passenger. It takes direction based on the current “state” of the particular booking conversation interface by messaging with the internal and external backend services that access customer/corporate profile information, flight schedules, fares information, seat availability information from the host CRS, and the traveler's master reservation record 100 that is in process of being created during the booking session.

The reservation booking process is concluded by storing a master reservation record 100 containing all reservation information. The traveler is provided final confirmation during the booking session as well as a follow-up correspondence via a fax or e-mail 110. If the reservation has been made the same day as scheduled travel, the confirmation record will be immediately activated for boarding the flight at the airport gate.

Should the traveler at any time require human assistance during the booking process, context booking information that has been collected thus far will be transferred via a Computer Telephony Interface to the airline's host reservation call center. This will allow minimal re-specification of information from the traveler in order to complete the booking.

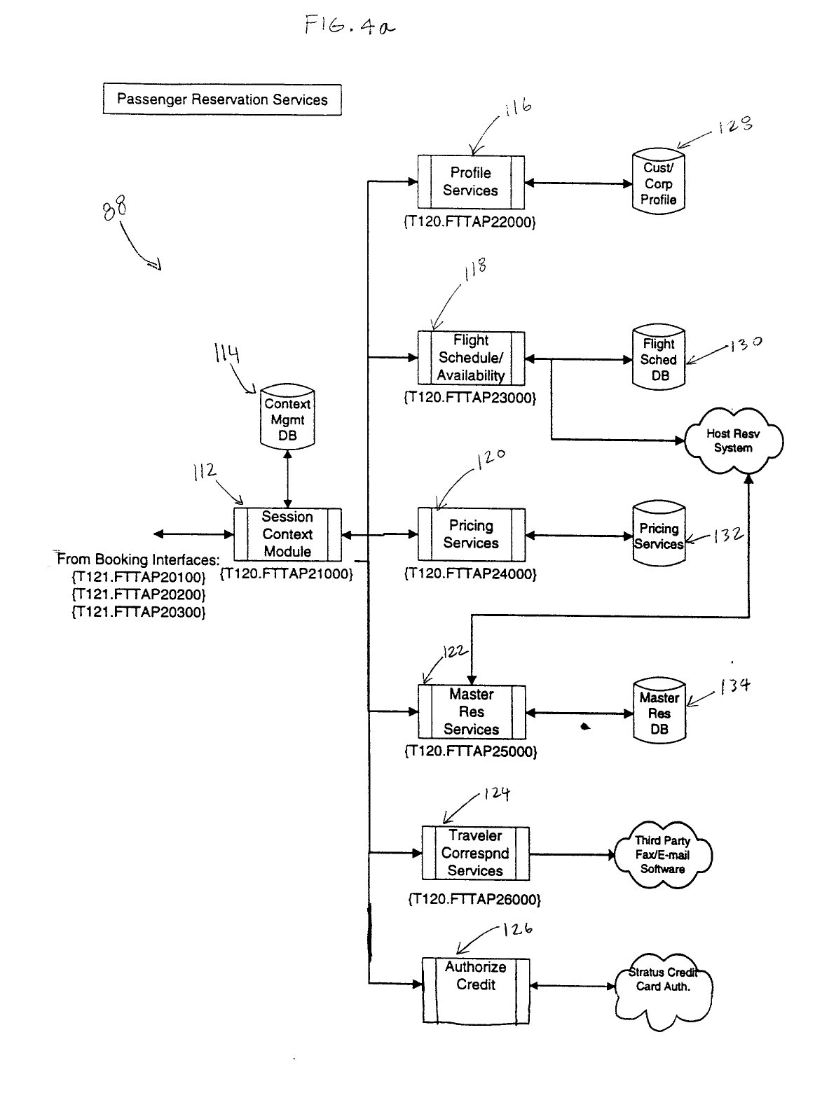

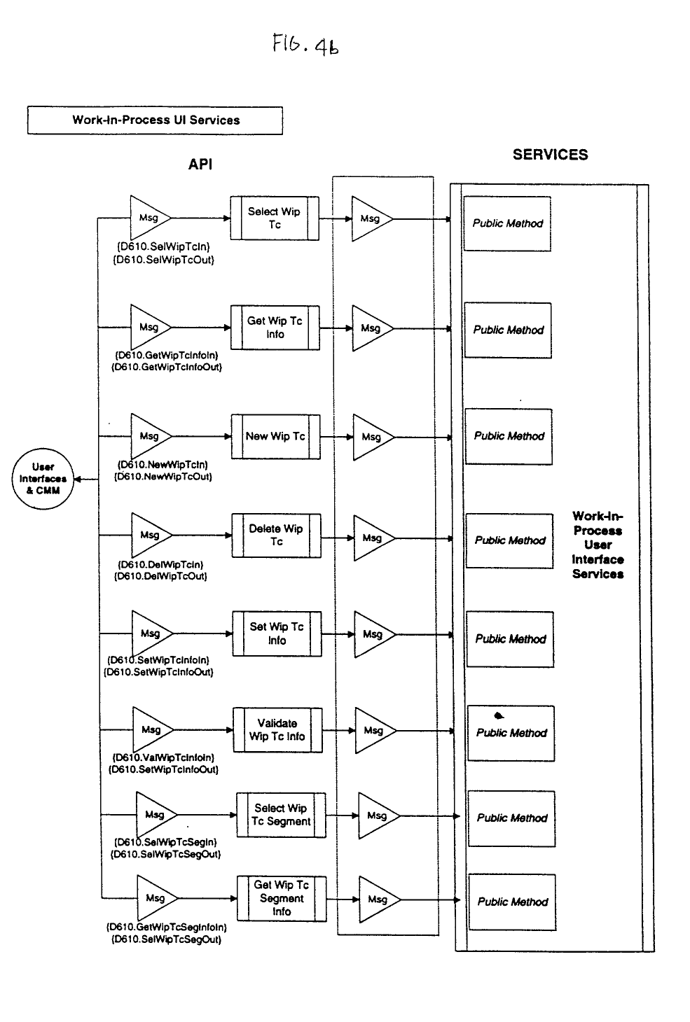

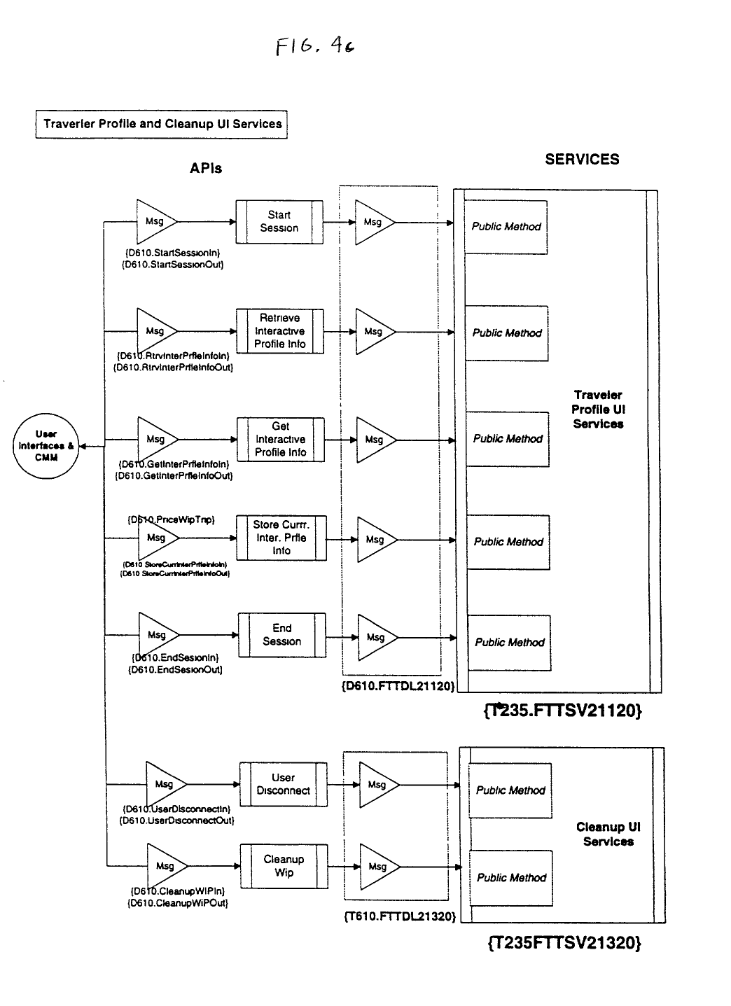

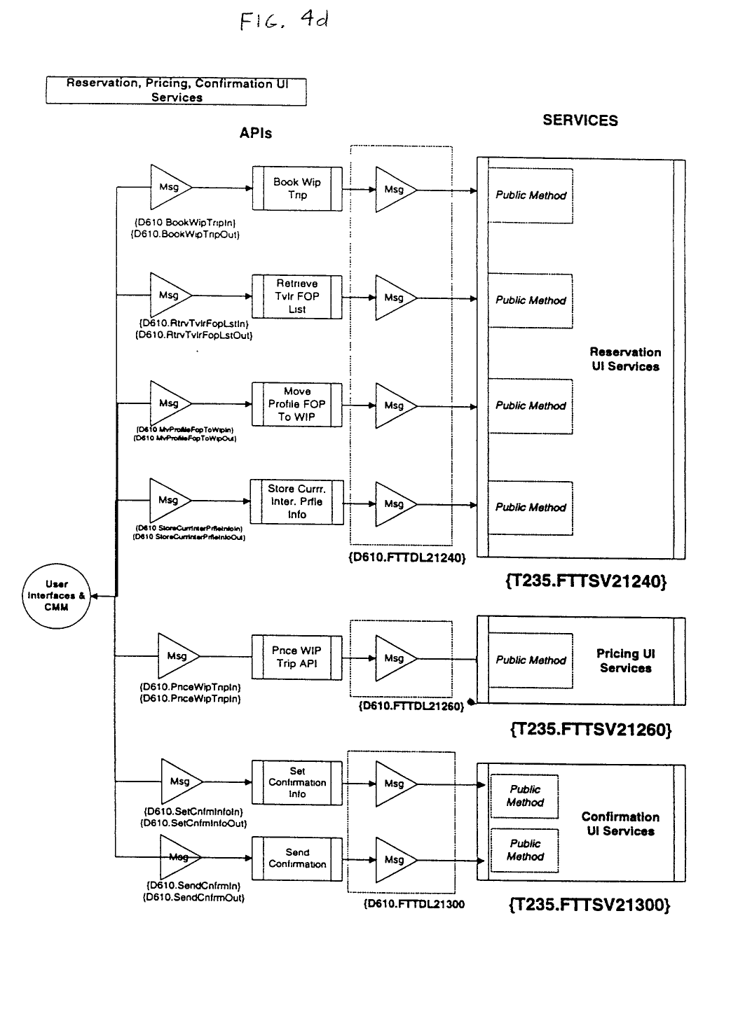

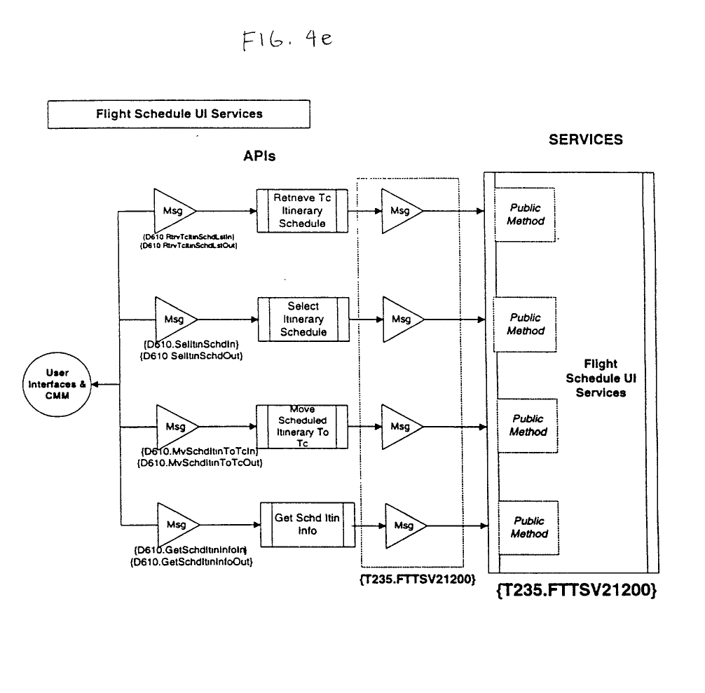

FIG. 4 is a more detailed diagram showing the interrelationship of modules and databases relating to the passenger reservation services 88. Session context management module 112 contains a collection of services that provide the main interface between the various user interfaces and back-end services of automated travel system 10. It maintains the user session context including all information relevant to a booking being created or modified.

Context module 112 provides a robust API to the user interfaces of the automated travel system of the present invention. Context module 112 ensures that data and requests passed to back-end services are functionally valid. Furthermore, Context module 112 also maintains all information related to a traveler's work in process for a booking transaction. It obtains information from the traveler profile database 128 that is used to minimize the amount of work a traveler needs to do to create or maintain a booking.

Although it does provide limited services to allow a particular user interface to retrieve individual values, context module 112 is not intended to be the primary means through which each user interface retrieves data for display back to the user. Each type of user interface (e.g., telephone, GUI) will have a separate module, which has access to all context data. This module is used to retrieve data in a way that is optimized to the specific user interface type. For example, a telephone user interface uses recorded prompts to “display” data. Therefore, the display data for a telephone user interface retrieves context data and converts it to prompts before passing it back to the user interface.

GUI-type user interfaces, such as the corporate desktop booking conversation 84 or the kiosk booking conversation 86 on the other hand, can make use of larger chunks of data, as well as a greater variety of data types (e.g., numbers, dates, text), all with different formatting requirements.

Context module 112 is simply a library of called services. These services, in turn, either perform work on the user session context data 114, or make service calls to back-end Fast Track Travel services. The called services include Work in Process (WIP) Trip UI Services (See FIG. 4b); Traveler Profile UI Services (See FIG. 4c); UI Clean Up Services (See FIG. 4d); Reservation UI Services (See FIG. 4e); Pricing UI Services (See FIG. 4f); Confirmation UI Services (See FIG. 4d); and Flight Schedule UI Services (See FIG. 4e).

As shown in FIG. 4a, context module 112 utilizes the called modules listed above to provide services in each of the following areas: user authentication, user profile update and retrieval, trip and trip component storage and retrieval, session context management, trip component specification, flight schedule retrieval, new trip creation, existing reservation review and modification, trip pricing, new reservation creation, reservation confirmation, and session clean up.

A Session is a single interaction of a user with the automated travel system of the present invention. The user could be acting on their own behalf, or acting for others (e.g. a travel coordinator, a customer service representative, third-party travel agent, etc.). Every operation within the automated travel system of the present invention is tied to an individual session via the assigned Session ID. Session ID is an identifier that is unique for one particular interaction with one particular user. A user can be working on trips for multiple travelers.

A Session can be “transferred.” For example, a user interacting with automated travel system of the present invention via the voice interface may encounter difficulties. In this case, the user can request to speak with a customer service representative (“CSR”). The user's session context data can be transferred from the voice interface to a PC interface being operated by the CSR.

The Session context consists of traveler profiles, flight schedules, traveler trips, and context pointers. Tied up in these structures and data is the “work in process” (“WIP”) for the session. Since creating and modifying traveler trips is the main point of a session, traveler trips are also the center point of the work in process. The WIP for a traveler is a new or existing trip that is being built or changed. Traveler trips are maintained in a session trip area. In one embodiment of the present invention, there are three types of trips maintained in the session trip area: new, stored, existing.

New trips are trips which are in the process of being made by the user. Within the session trip area, a new trip typically maintains a confirmation number from 0 to 20 until booked. Similarly, existing trips are trips which are already booked for the travelers active in a session. Existing trips maintain a reference to their actual confirmation number (from master reservation database 134) within the context module. When selected for modification, they become part of the WIP.

Stored trips are templates that have been built by the traveler to aid in the creation of new trips. They have pre-set information such as origin city, destination city, and flight numbers. They are stored in the same data structures as new or existing trips and can be moved into the WIP as the beginning of a new trip. These trips are assigned a confirmation number of typically less than −1 within the session trip area. Stored trip components also have a code of “stored”, but a confirmation number of −1. They can be used as a template in building one component of a trip.

The WIP that exists during a given session is maintained by “pointers” into the trip data structures. Each traveler active in a session can have one WIP at one time. The session user typically creates or modifies one trip for a traveler. A pointer or reference variable is maintained indicating the WIP trip for a traveler. The trip is then the recipient of any action performed for that travelers at the trip level. Likewise, there is pointer which references the WIP trip component. Again, any action initiated at the trip component level for this traveler will be performed on the WIP trip component. These pointers also exist for the segment and leg level for the purpose flight selection and construction.

Context module 112 assumes that each user interface is performing field-level validation tasks as it goes along, for example, city names, dates, etc. When a service call is made to context module 112 that requires any of the service discussed above, context module 112 will perform transaction-level validation. If there are errors, Context 112 module will log each error in the Session Messages area and pass back a return code indicating that there were errors in the transaction. It is then the responsibility of the user interface to retrieve and process the errors in a manner appropriate to that particular user interface.

For situations involving retrieval and “display” of a list of data, the data must be sorted and/or filtered prior to display. The manner in which it is sorted or filtered can be specified in a variety of ways: default or implied, user profile, manually specified override of user profile or default, and so on.

Customer/corporate profile database 128 integrates traveler preference with corporate travel policy information such that individual booking sessions can be biased to a particular customer/corporation. Traveler preference information includes, but is not limited to the following: traveler biography information (e.g. Name address, phone, email, fax, etc.); supplier preferences/affinity membership numbers; flight preferences (e.g. seat, meal, equipment); stored trips of most frequently flown itineraries; and preferred personal forms of payment.

Similarly, corporate travel policy information includes, but is not limited to, the following: corporate biography information (e.g. name, address, contacts, taxes, locations, divisions); policy information (e.g. preferred suppliers discounts, travel policies); and corporate travel reporting information.

Customer/corporate profile 128 database provides key point of sale marketing information to every booking that is made through the automated travel system of the current invention. Every booking is stored with the traveler's unique identifier, linking present and historic bookings to corporation/employee.

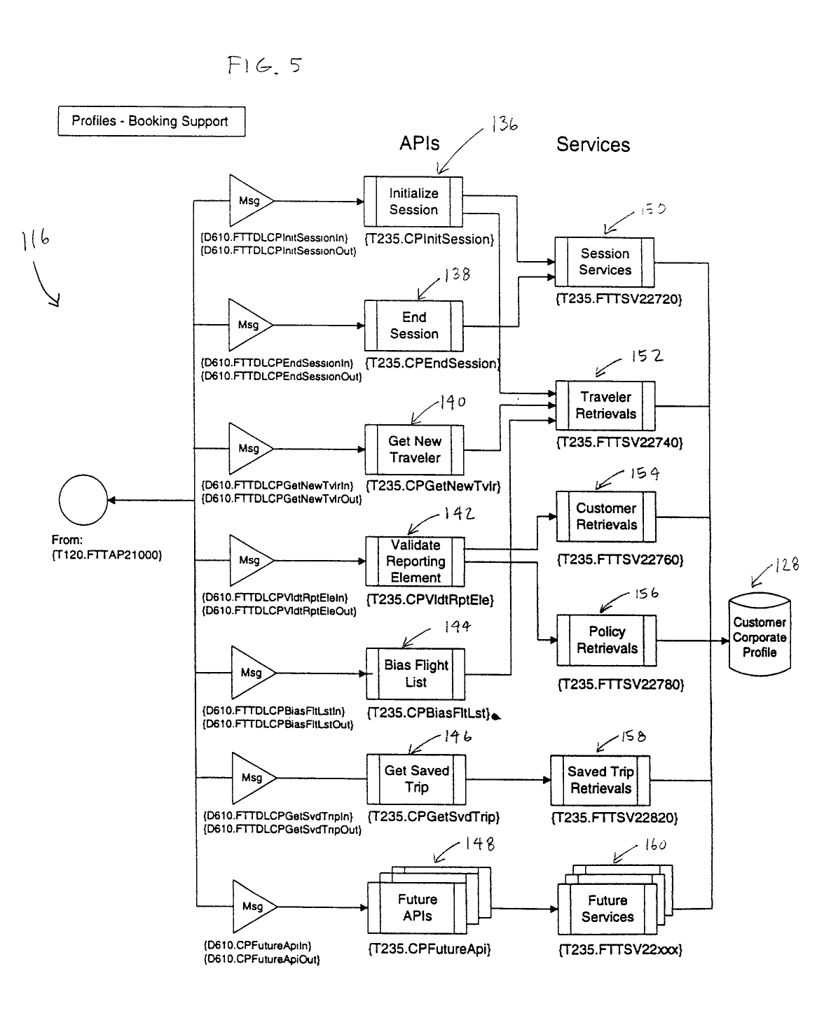

Referring now to FIG. 5, profiles booking support services system 116 retrieves information from customer profiles database as needed by the online booking (voice and online) channels/services. The functionality of profiles booking support services subsystem 116 is provided through APIs as set forth below.

The initialize session API 136 validates the user's logon to ensure they are recorded in the customer profiles database 128. Furthermore, initialize session API 136 also establishes a session log and looks up and returns parameters (i.e. the “interaction profile”) that are used to configure the user's interaction with the automated travel system of the present invention. Moreover, initialize session API 136 also returns the traveler's profile information including personal data, airline frequent flyer numbers, seating and other flight preferences, forms of payment, and notification information (fax and email addresses).

End session 138 records summary statistics at the end of a user session. Get new traveler 140 allows an user designated as a travel planner to retrieve the profile information for a second or subsequent traveler.

In one embodiment of the present invention, each customer corporation may specify one or more accounting-related fields, such as a charge number or cost center, that must be entered during the booking process. Validate reporting element API 142 validates the code(s) entered by the user against an established list of valid values provided in advance by the customer corporation.

Bias flight list 144 reviews a schedule of flights that has been retrieved based upon a basic scheduling request (i.e. origin-destination and date) and applies a biasing “score” to each flight. In so doing, the booking application is able to filter and sort the flights appropriately before presenting them to the user. Biasing is done along three dimensions considering (a) corporate policy, (b) agency biasing, and (c) traveler preference. Corporate policy considers current airline contracts and other policy rules of the corporation (i.e. class of service, etc.). Agency biasing reflects contracts or other carrier preferences of the distributor (if any). Traveler Preference includes airline choice, class of service, equipment type, and a number of other coded preference types.

Get saved trip API 146 retrieves a list of stored trips from the database and returns them to the booking application.

With the exception of initialize session API 136 and end session API 138, all of the services available through the above-identified APIs are typically read-only to customer/corporate profiles database 128. All maintenance of customer/corporate profiles database 128, including updates to the traveler's profile and creating/updating stored trips, is done through the System Maintenance (not shown).

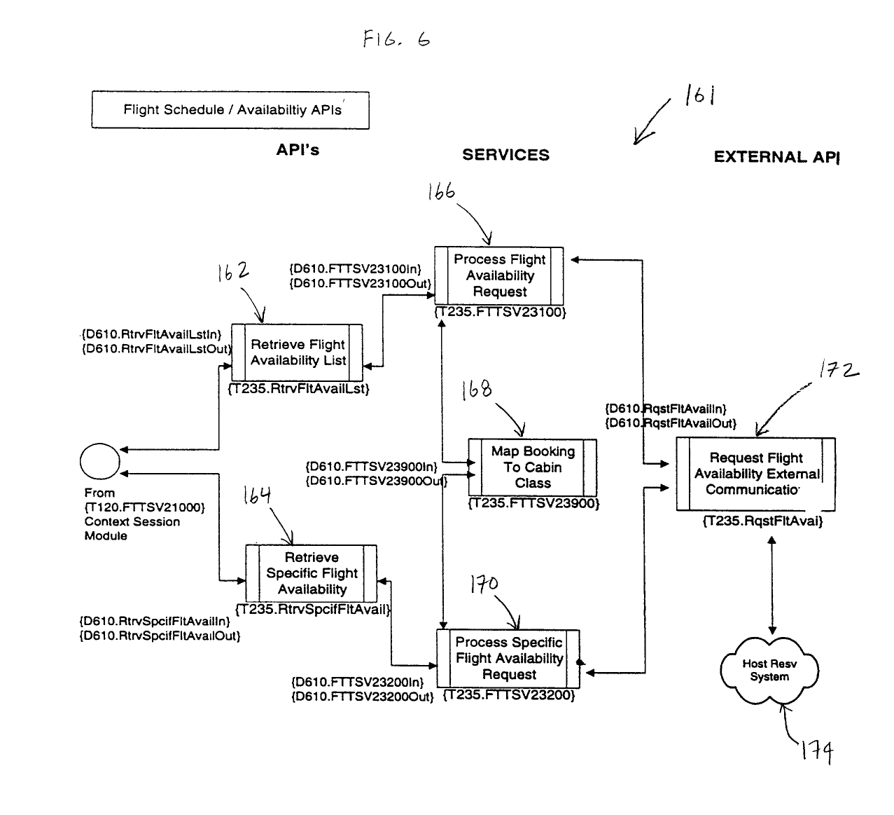

Referring now to FIG. 6, flight schedule/availability APIs service system 161 provides functionality between session context module 112 and flight schedule database 130. Context module 112 calls the retrieve flight availability list API 162 to request a list of flight schedules and availability by booking and cabin class for a given market and travel date. The requested information is retrieved via a call to the availability request external communication API 172. The availability by booking class returned is mapped to its respective cabin classes 168 and then returned to the requesting context module 112 along with other flight schedule details retrieved.

Similarly, context module 112 also calls the retrieve specific flight availability API 164 to request availability by booking and cabin class on a specific flight departing on a given date. Flight availability on a specific flight is also retrieved from availability request external communication API 172. The availability by booking class returned is mapped to its respective cabin classes 168 and then returned to the requesting context module 112 along with other flight schedule details retrieved.

Request flight availability external communication API 172 provides flight schedule information and availability by booking class down to the flight segment level. This information is requested from a host reservation system 174 using external communication protocols.

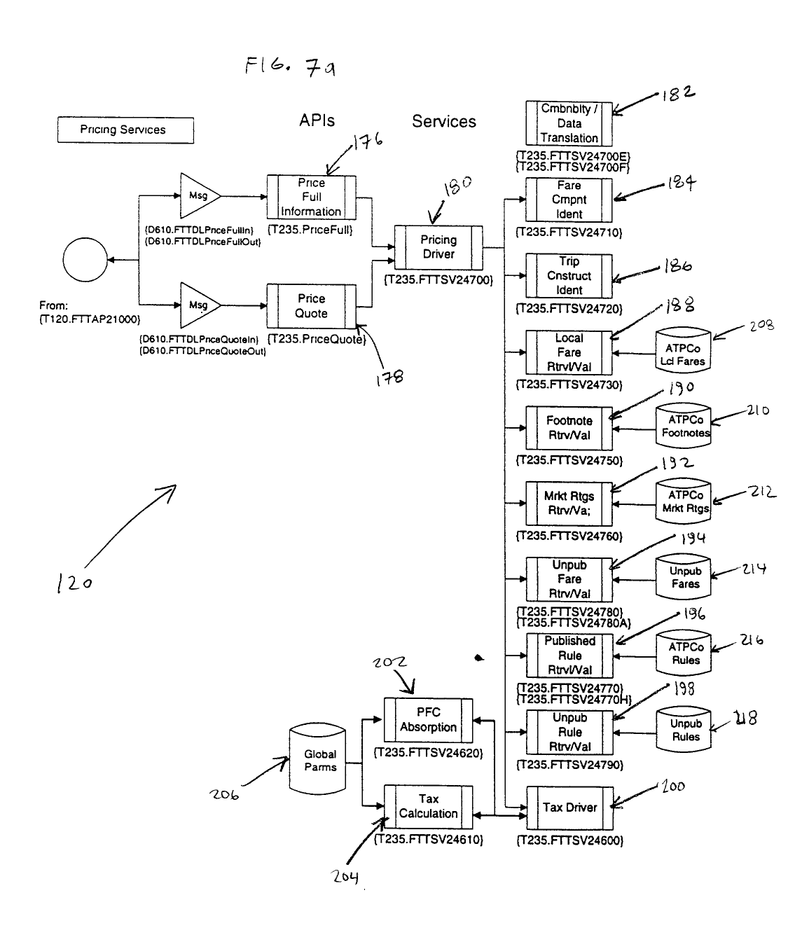

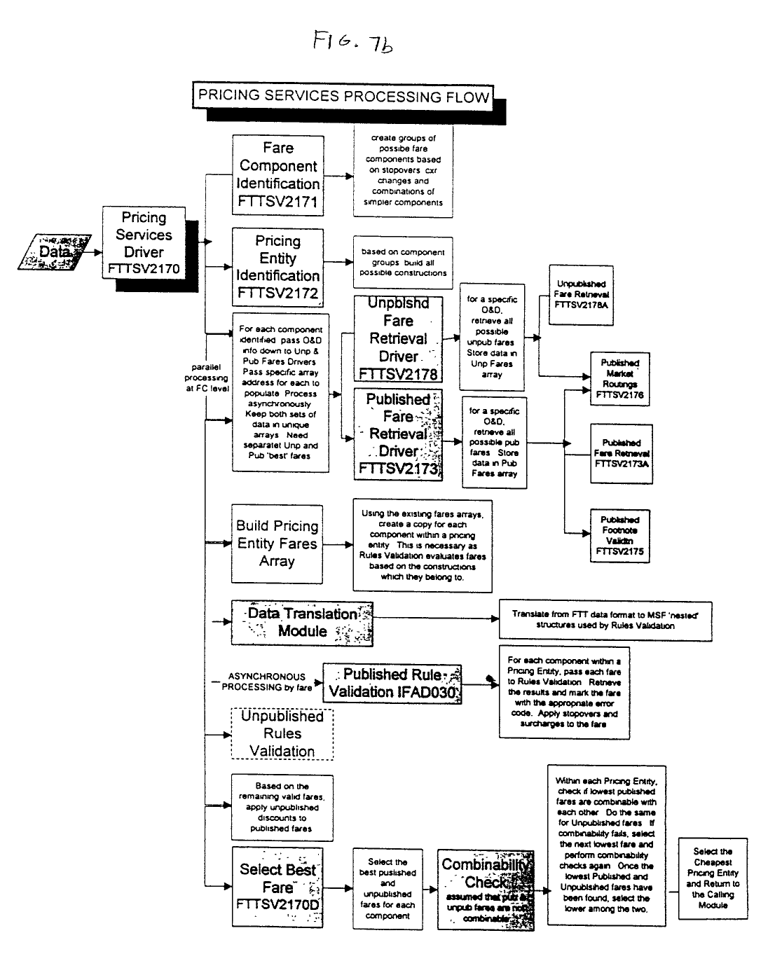

Referring now to FIG. 7, pricing services 120 is responsible for determining the lowest fare for a traveler's given itinerary. Pricing services 120 provides this functionality using a series of APIs. For example, price full information 176 returns a total sale amount of total fare and tax inclusive of detailed fare, surcharge, and tax information. Price quote 178 returns a total sale amount of total fare and tax without support detail.

Pricing services driver 180 is the driver module for all pricing within the automated travel system of the present invention. Pricing services driver 180 will receive pricing requests and service that request by making the appropriate calls to fare retrieval and validation logic. Furthermore, pricing services driver 180 will accept pricing requests and perform the necessary functions to price the itinerary. Typically, the input into pricing services driver 180 is coupon level information as well as customer and corporate information.

Initially, pricing services driver 180 will begin by calling validate trip information if the field has a value. Additionally, pricing services driver 180 is coupled to various other modules that can be called to return data according to the processing required. These modules include: fare component identification module 184; trip construction identification module 186; local fare retrieval module 188; joint fare retrieval module (not shown); footnote retrieval and validation module 190; market routings validation module 192; unpublished fare retrieval/validation 194; published rules retrieval/validation module 196; unpublished rule retrieval/validation module 198; and tax driver module 200.

Fare component identification module 184 identifies possible trip components within an itinerary. This is done by grouping the itinerary segments together in different ways to form possible fare components. Furthermore, fare component identification module 184 prevents illogical components from being generated.

Trip construction identification module 186 identifies all possible combinations of trip constructions that, when combined, can be used to price all specified travel. This process will produce pricing entities (not shown), each describing a different combination of logical trip constructions that may produce the lowest ticket price.

For each component identified, pricing services driver 180 typically will seek to determine the unpublished fare for the component. This process typically involves retrieving the agreements and calling unpublished footnote retrieval/validation module 190. After doing this, the unpublished fare is retrieved using unpublished fare retrieval/validation module 194. Next, the published routings retrieval/validation module 196 is called. Additionally, the process returns an array of unpublished fares.

Similarly, pricing services driver 180 can determine the published fares for the components. Typically, this can be accomplished by calling retrieve local published fares module 188. Retrieve local published fares module 188 will retrieve published local fares and add all qualifying round-trip and one-way fares to the fares array.

The process continues by calling published footnote retrieval and validation module 190. This module will apply footnote restriction against the travel dates. Furthermore, the process will call published routings retrieval and validation module b192 to apply routings restrictions against the itinerary. After this process is completed, an array of published fares is returned.

By following these processes, the pricing services driver 180 can create a separate published and unpublished fares array for each component within a pricing entity (not shown). Previously, fares arrays were only unique within each component. Now they will be unique by component, within each pricing entity. This is necessary as a fare's validity depends directly on the construction to which it belongs. For example, a round-trip fare from Chicago to Minneapolis-St. Paul can be valid if the construction is a 2 component construction which commences, for example, on Feb, 3, 1995. It is possible for the same fare to be invalid if included in a 3 component construction which commences on, for example, Jan. 25, 1995.

Pricing services driver 180 will also perform published rules validation. Typically, this involves perform a data translation service that maps to a nested format which published rules retrieval/validation module is expecting. Typically, for each fare pricing services driver 180 will process the following steps asynchronously. Initially, the module will retrieve or validate the published rules by calling published rules retrieval/validation module 196. Published rules retrieval/validation module 196 validates published rule restrictions. Perform data translation service (not shown) will map nested the published rule restrictions from rules to flat PSD data structures, for example, map fares.

Furthermore, in another embodiment of the invention, pricing services driver 180 can also determine the cheapest pricing entity based on total published fare. Initially, this involves performing fares sorting. In this process, the cheapest fare for each component is selected by filtering through its fares array. Furthermore, the process performs combinability validation at the construction level, for each pricing entity. For example, it typically is possible to combine published round-trip fares with other published round-trip fares. OW published fares need not go through combinability checks. Moreover, the process would use the rule number and fare basis code as the validation criteria. Finally, the process will select the pricing entity with the cheapest fare.

In another embodiment of the present invention, pricing services driver 180 can determine if any unpublished agreements correspond to the fares of the selected pricing entity. For each component within the selected pricing entity, the process will match the selected published fare with an unpublished fare. The process will next perform a combinability validation within each construction using the ticket designator as validation criteria. If combinability is passed, the process will call unpublished fare retrieval/validation module 194 to retrieve and validate the unpublished rules. In one embodiment of the present invention, the published rules violations can be over-ridden by the unpublished rules checks. The process will proceed by selecting the cheaper between the unpublished and published price and returning the lowest ticket price and booking information. FIG. 7b illustrates the processing flow of pricing services driver 180.

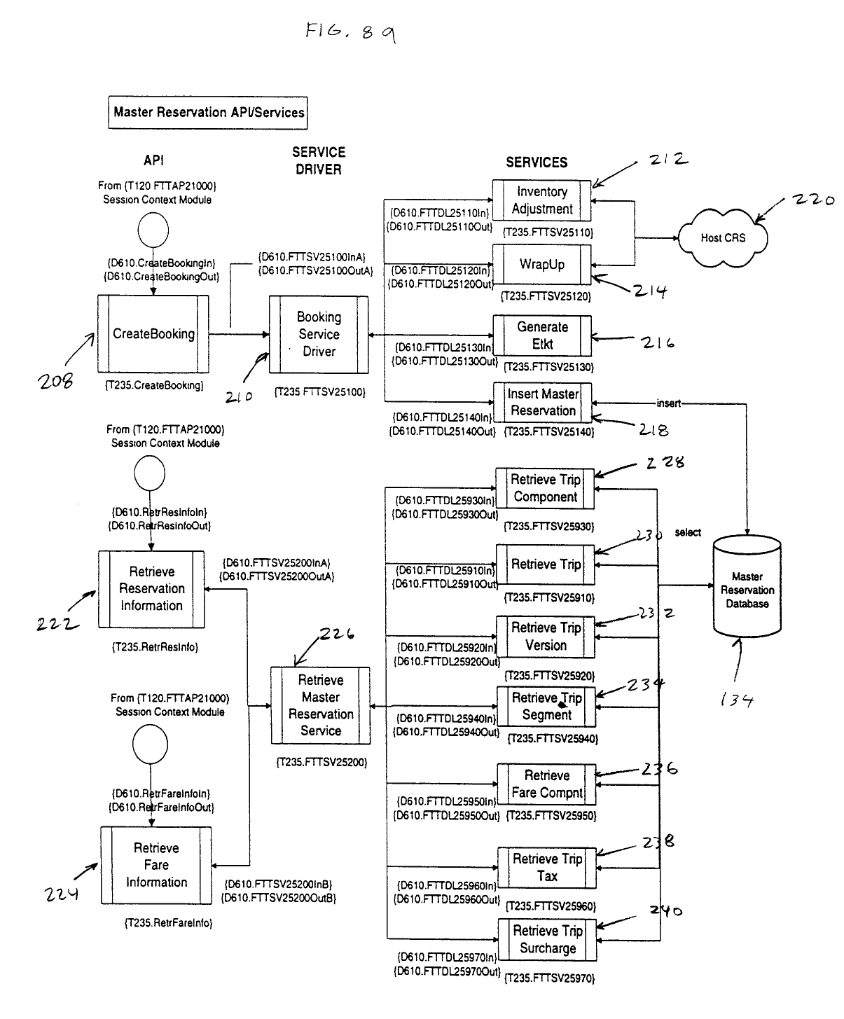

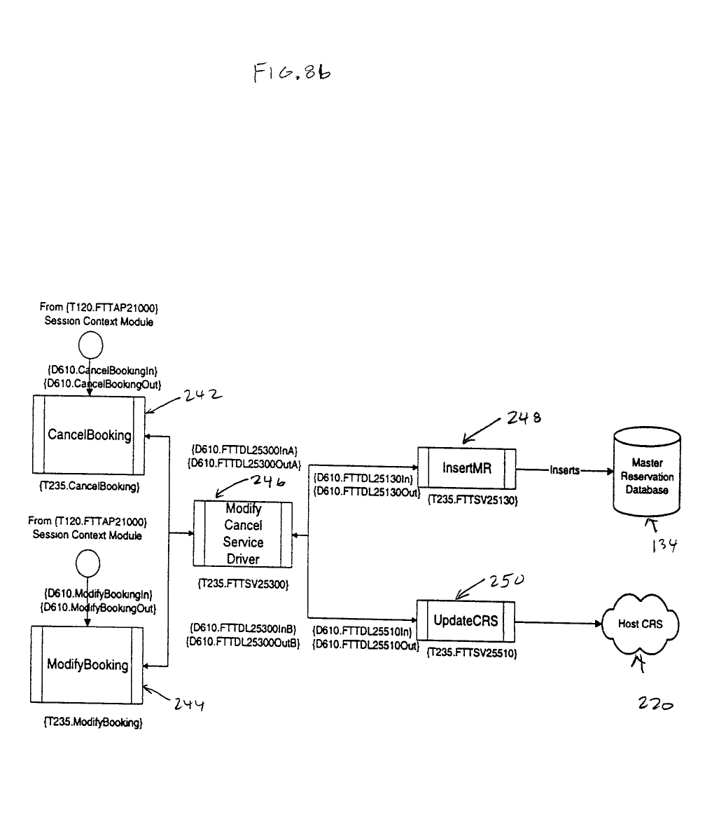

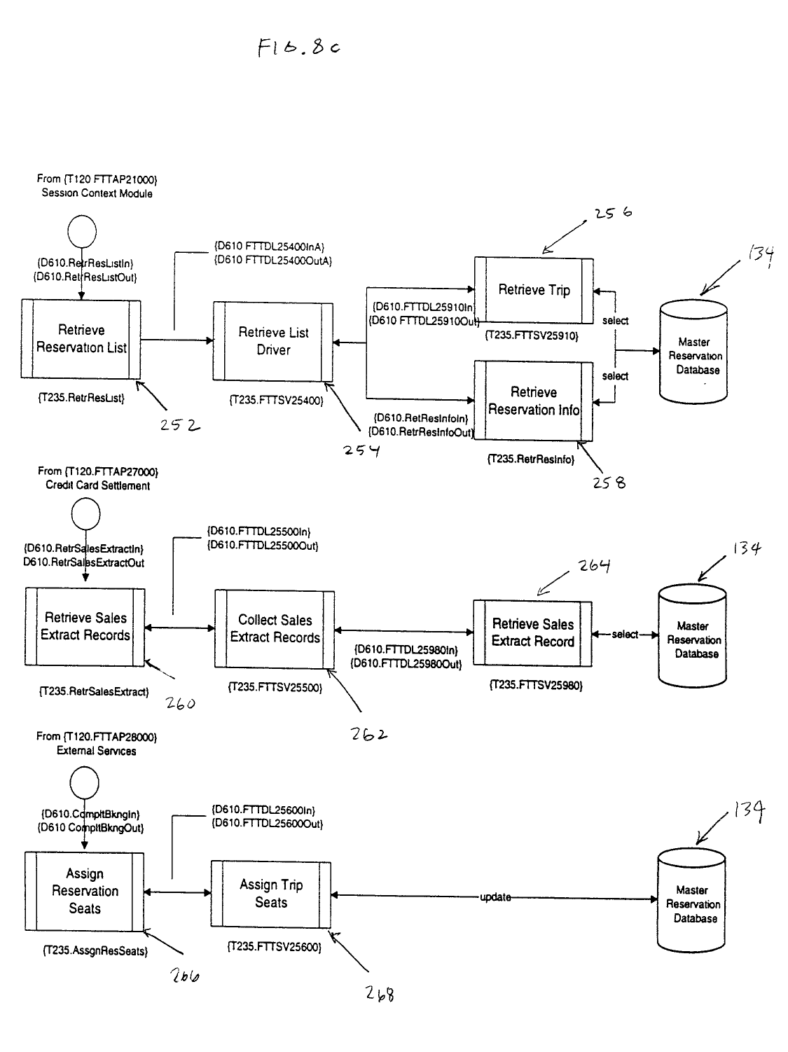

FIG. 8 illustrate the APIs, service drivers and services available to master reservation APIs/services 122. Master reservation APIs/services 122 performs all of the inserts, updates and retrieval to/from master reservation database 134. Create booking API 208 uses the input itinerary and the pricing component to call a service to generate an electronic ticket number. Create booking API 208 is coupled to booking service driver and is capable of making calls to Host CRS 220 to reserve a seat and, furthermore, will store all reservation information into master reservation database 134. Seat assignments are accomplished by sending special service request (“SSR”) during wrap-up.

Retrieve reservation information 222 uses either the ticket number or a system reference number to return the trip information to session context module 112. Similarly, retrieve fare information 224 uses either the ticket number or the system reference number to return the fare information to the session context module 112.

Cancel booking API 242 uses the system reference number to create a new version in master reservation database 134 and set the trip and reason code to cancel. Service calls to host CRS 220 can also be made to adjust seat inventory. Modify booking API 244 uses the system reference number to create a new version in master reservation database 134 with modified trip information. Furthermore, service calls to host CRS 220 can also be made to reflect any updates to the traveler's trip.

Retrieve reservation list API 252 will return the list of existing reservations. Similarly, retrieve sales extract API 260 will return all sales records generated since the last extract. Assign reservation seats API 266 will update the trip's seat assignment or any special request response from the Host Reservation System.

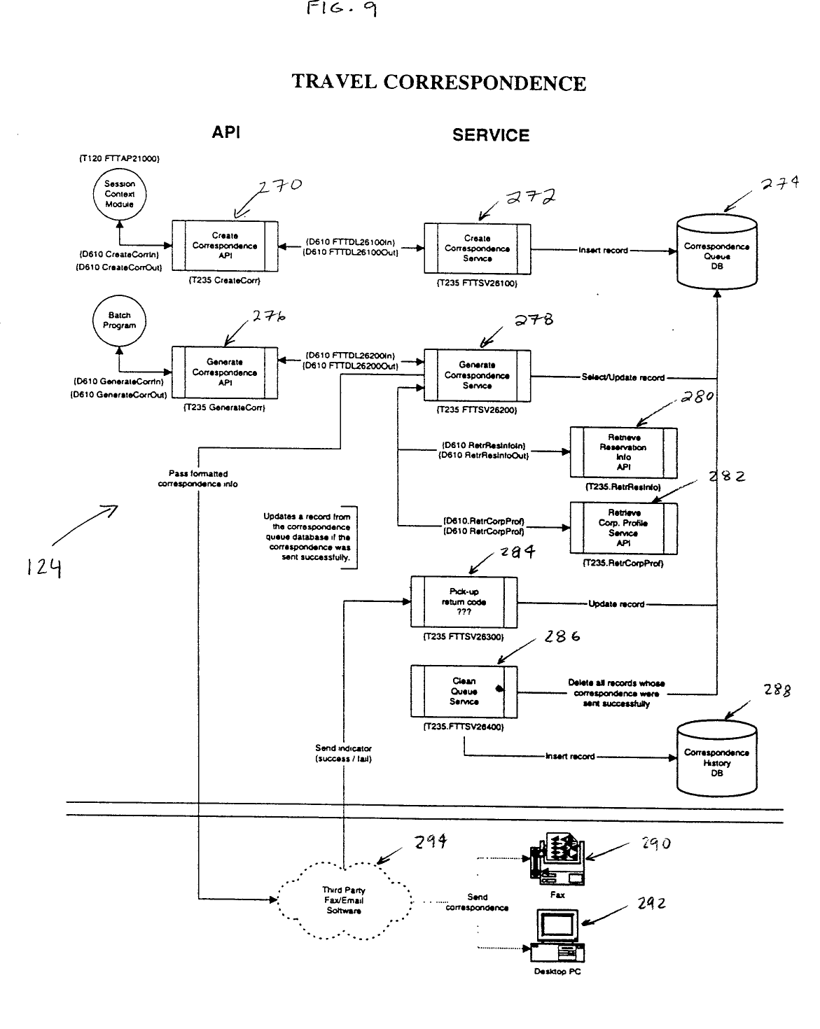

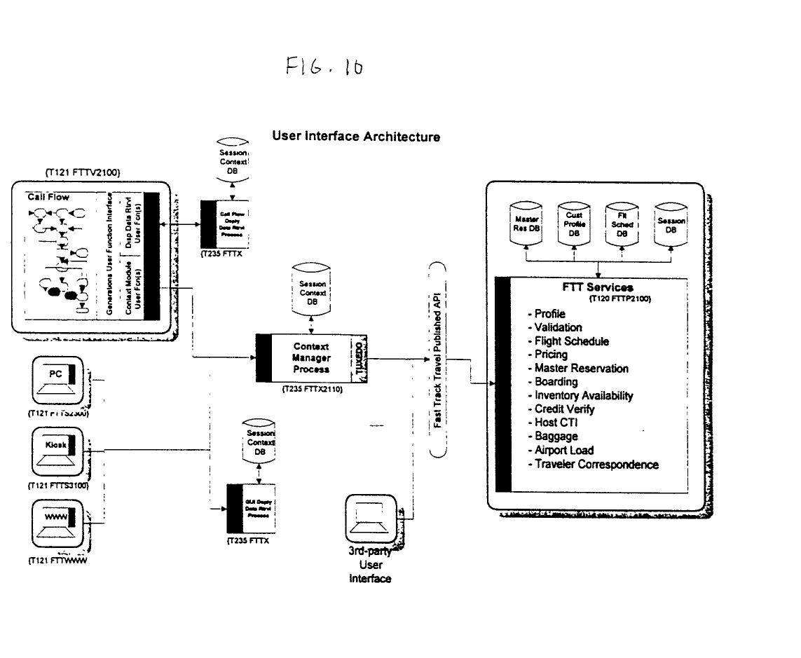

Referring to FIG. 9, travel correspondence service 124 concludes the booking reservation process. The reservation booking process is concluded by storing a master reservation record (not shown) containing all reservation information. The traveler is provided final confirmation during the booking session as well as via a correspondence such as a fax 290 or an e-mail 292.

Travel correspondence services 124 creates and generates a travel correspondence. The process of creating a correspondence includes the passing of trip reference number, customer id, and a communication buffer array which holds the communication mediums and addresses to be used. These data from the context session module 112 are then inserted into the correspondence queue database 274.

The travel correspondence is then generated by selecting and updating a record from correspondence queue database 274. The output data layout of this service is then formatted by accessing other services using API calls.

Retrieve reservation information API 280 and retrieve corporate profile information 282 are called to generate correspondence information. The generate correspondence process is concluded by passing the output data layout to a third party fax/email software 294. Third party fax/email software 290 is responsible for sending all travel correspondence.

In addition to retrieve reservation information API 280 and retrieve corporate profile information API 282, there are two other services used in the travel correspondence system 124. Pick-up return code service 284 receives the return code passed by third party fax/email software 294. It then updates a record from the correspondence queue database on the status of the correspondence. On the other hand, clean queue service 286 deletes all records from the correspondence queue database whose correspondence were sent successfully. Clean queue service 286 is concluded by inserting a record from the correspondence history database 288 for future references.

There are several interfaces that the system of the present invention provides for linking to airlines. Several EDIFACT message formats can be used to demonstrate the full functions of the system of the present invention. Some of the message formats are currently supported by some airlines, and some will need to be developed. These message formats include the following: hybrid wrap-up request; hybrid wrap-up response; inventory adjustment request; inventory adjustment response; ticket issuance request (i.e. electronic ticketing); and ticket issuance response (i.e. electronic ticketing).

The ticket issuance request and response messages are a series of messages that define ticket issuance, display, void, print, reissue/refund and history display. There is an “action desired” code that specifies which of the message types is being processed.

In order to correctly process EDIFACT messages between legacy systems and the system of the present invention, several control type functions are typically required. These functions maintain sessions between the two systems and include Clear/Terminate Request, Clear/Terminate Response, General Error/Advice Messages, General Error Response, Application Status Request, and Application Status Response.

When shopping, customers will often generate a complete booking and request a price quote just to determine the cost of a trip. After making the booking, the customer can then decides not to actually complete the transaction. It is the responsibility of the system present invention to send the clear/terminate request when this occurs. This message will clear the session, and return inventory to the correct flights on the legacy system that the system of the present invention interfaces with.

When the system of the present invention determines that the legacy system is not responding, it will attempt to reestablish the session by periodically sending an applications status request. Once an applications status response is received, the session is reestablished, and processing can continue. At this point, the automated travel system of the present invention typically will assume that all applications sessions were lost.

Specific error codes can be returned within the ERC segment of any of the response messages. If the legacy system is unable to determine the specific error within a message, a generate error message is sent either in the CONTRL or the GGERES Message formats.

In one embodiment of the present invention, the flight availability is provided by the legacy system. Accordingly, the following EDIFACT formats can be used: Product Availability Offering Request and Product Availability Offering Response. These formats will require a market, date and time to be input to the legacy system and will return all flights serving that market for that date and time.

The system of the present invention provides for Bill at Use functionality that will be discussed below. However, an understanding of the usage codes from the airline's electronic ticketing system and the corresponding action taken by the system of the present invention is provided in the examples illustrated in Figures B20.

The system of the present invention also provides for a method for reducing the costs and enhancing revenue controls associated with airline travel distribution. As discussed above, bill per use is considered a method for simplifying travel distribution, eliminating unnecessary or redundant work, and improving an airlines ability to employ economic price discrimination and revenue management principles. Bill per use involves a set of complex but flexible features which can be molded to achieve a wide range of desired outcomes. While some of these features can be applied independently, several are potentially inter-related and must be assessed relative to each other.

The goal of bill per use is to eliminate much of the non-value added work discussed above with respect to existing systems. Bill per use eliminates the issues identified above by effectively combining the sale and usage transactions into one centralized transaction. This is very analogous to the situation today when a passenger buys a ticket at the last minute at the airport gate. Because the sale and usage occurs almost at the same time, the need for verification and reconciliation is almost eliminated.

One way of thinking about bill per use is a “pay as you go” mentality similar to the car rental and hotel industry. Using the system of the present invention, reservations can still be made in advance, planning and usage patterns can still be used to economically price discriminate, capacity/inventory controls can still be used to manage yields, and billing to the customer can still be executed separate from the calculation of billing (i.e. pricing).

Furthermore, for processing purposes, bill per use can also internally separate disjointed transactions that today are combined into a single transaction based on artificial compatibilities. For example, today a passenger can get a single ticket composed of two one-way fares on different airlines an itinerary that could have also been issued as two separate tickets. By creating this multi-leg transaction, airlines unnecessarily increase the level of complexity (e.g. unnecessary interline processing, paid less used refund calculations, etc.) and potentially create additional work. Through bill per use, these transactions can be processed separately transparent to the customer.

It should be noted that the bill per use functionality is only one component of the system of the present invention. Bill per use enhances the overall benefits of the automated travel system of the present invention by reducing the cost of distribution, and enhancing revenue control at the transaction level. Bill per use also provides additional benefits to both the traveler and to the airline.

In one embodiment of the present invention, bill per use provides integrated transaction control from booking to usage by combining two separate transactions into one (i.e. sale & use). In so doing, the processing is simplified and substantially reduced. Additionally, a more complete and meaningful transaction audit trail is made possible, for example, all sales represent actual usage.

In another embodiment of the present invention, bill per use eliminates the need for reconciliation by removing the advanced issuance of an accountable and specific travel authorization. Therefore, the work associated with repeated verification and reconciliation, for example, booking to ticket, ticket to flight, and usage to sale, is eliminated.

In yet another embodiment of the present invention, bill per use eliminates refunds and reissues/exchange transactions. Typically, these transactions commonly account for 20-25% of an airline's sales transactions. Furthermore, while a typical major airline issues only 20-30% of new its new sales through its own stations, it commonly processes 80-90% of all exchange transactions. It should be noted that this benefit is also applicable to the customer.

Additionally, the bill per use method provides enhanced revenue control at usage. Because the sale and usage transactions are centralized under the bill per use method, the centralized transaction control allows an airline the ability to price or adjust price at time of usage. This feature can be used to automate collection of penalty/change fees, automatically verify fare qualification at usage, and inhibit “hidden city” ticketing and other coupon throw-away or coupon switching schemes.

Bill per use provides the system of the present invention with features that add flexibility without compromising existing requirements. For example, bill per use provide the following features: Penalties/“No Show” Deterrence, Cash Flow/Deposit Schemes, Refunds and Reissues/Exchanges, Revenue Control Passenger Billing, as well as Revenue Accounting Airport Interfaces.

It should be noted that the features of the bill per use functionality are potentially inter-related. For example, decisions regarding the passenger billing feature may impact cash flow issues. Conversely, there are also ways of avoiding some of these potential cause-and-effect relationships. For example, passenger billing can be implemented independent of cash flow management using an intermediate escrow debit account. These concepts and more are discussed below.

Since bill per use eliminates a separate sale event from usage, the automated travel system of the present invention initially addresses the concern of when the issue date should be defined. Under existing systems, the sale or issue date represents the point at which the customer commits to purchase of travel—locking or guaranteeing price. Typically, fare guarantee refers to the price assigned to a given fare as defined by fare basis code. A change in price due to fare qualification (e.g. number of days booked in advance) is not an issue in this section.

There are three basic options for defining issue data. For instance, issue date can equal the booking date, the departure date, or the issue date is a separate customer driven parameter. In a situation where the issue date equals the booking date, it should be noted that approximately 60% of tickets are issued the same day as initial booking. Furthermore, it is also possible that the issue date can effectively occur before booking date (e.g. using a previously issued and unused ticket for a new booking) and the issue date can also occur in the absence of a booking date (e.g. redeeming a previously issued and unused ticket at the gate).

In a situation where the issue date is equal to the departure date, this recognizes that approximately 8-10% of tickets are issued the same day as first scheduled departure. These transactions can be considered bill per use transactions but without many of the benefits.

Similarly, the issue date can be a separate customer driven parameter. A minimum of 30% of tickets are issued on a date between initial booking (assuming there is one) and first scheduled departure. Keeping issue date a separate customer/corporation driven parameter does not inhibit the two other options from effectively occurring.

With many existing systems, the customer chooses a when issue date occurs. The key concern with fare guarantee is when fare changes after time of booking but before departure date. Whether a customer cognitively chooses the issue date for reasons of guaranteeing price or whether their decision can makes a difference given the circumstance are key questions which must be scrutinized. For business travel on relatively stable, unrestricted fares, actively choosing issue date can effectively be a moot point or a zero sum game. For leisure travelers taking advantage of an excursion fare sale, guaranteeing fare immediately is an important practice which can make a difference (e.g. lock fare before a fare sale expires).

For an airline, one of the negative side-effects of locking price sooner than required is that it creates a need to address fare adjustment refunds. These refunds occur for two primary reasons: 1) a qualifying discount was not applied (e.g. senior citizen's discount), or 2) the fare use in pricing the ticket decreased after the ticket was issued but before travel. Purchasing a ticket more in advance than necessary increases the chances of probability of incurring fare adjustment requests (as well as exchanges and normal refunds).

It should be noted that not all customers qualifying for fare adjustments pursue them (e.g. they did not know the fare changed) and the relative volume of fare adjustments are low. However, the introduction of major fare sales do have the potential to trigger significant volumes. Fare adjustments can also manifest themselves as refund-due exchanges prior to departure.

The following examples illustrate the potential impact of fare guarantee where issue date equals the booking date or the departure date. For example, when a fare changes after booking date but before departure, the two examples below illustrate that one will result in a price increase and the other will result in a price decrease. It should be noted that the same considerations also exist when the issue date is a separate customer driven parameter.

### Example: Fare Increases after Booking Date but before Departure Date

If the issue date equals the booking date, the airline would not capture the potential revenue associated with a fare increase. The customer would lock into a price of travel before the price increase and potentially save. Conversely, if the issue date equals the departure date, the airline would capture additional revenue due to the delay in pricing the transaction. The customer would pay a higher price for travel due to the fare increase.

### Example: Fare Decreases after Booking Date but before Departure Date

If the issue date equals the booking date, the airline would avoid losing the revenue associated with the fare decrease as long as the customer does not recognize the fare decrease and request a fare adjustment refund or refund-due exchange. If the customer requests a refund fare adjustment, not only does the airline lose the revenue difference, but it may also incur the cost of processing the adjustment transaction. On the other hand, if the issue date is equals to the departure date, the airline would dilute revenue due to the fare decrease prior to departure. However, the airline would benefit from reducing fare adjustment refund transactions. The customer would benefit from any fare decrease prior to travel without the hassles of requesting fare adjustments and reissues/exchanges.

In general, for price sensitive travelers trying to qualify for restricted fares, fare guarantee adds customer value. The restricted fares they use are change relatively frequently creating the need to guarantee/lock price in advance (e.g. at the time of booking). On the other hand, for price insensitive travelers primarily purchasing unrestricted fares, fare guarantee may not add customer value. The unrestricted fares they use change relatively infrequently, and the net of fare increases and decreases over time may effectively be a zero sum game. Accordingly, a case for splitting fare guarantee functionality by fare type or travel type (e.g. corporate account versus the rest) can be made.

It should be understood that fare guarantee is not the same as qualification for discount fares by meeting rule restrictions. Airline's use fare rule restrictions to exploit planning and travel characteristics to manage revenue. Typically, this accomplished by segmenting the market of potential customer into groups based on the level of price that they are willing to pay, influencing or exploiting the demand for particular travel times/flights through price, or influencing or exploiting the demand for particular routings/airports through price.

With respect to restrictions, the only relevant restrictions are associated with segmenting the market of potential customers into groups based on the level of price they are willing to pay. Domestically, the key restrictions used for this segmentation are advance booking/purchase, minimum stay, and passenger type. Given an itinerary with specific flights and dates/times, the other two categories become irrelevant.

With respect billing or pricing advance purchase tickets, bill per use processes these transactions similar to how PRA audits these same fares after-the-fact. For example, a system pricing a transaction at time of departure can still assess whether a customer booked the necessary number of days in advance and is scheduled to stay over a Saturday night. For advance purchase/booking requirements, the key discriminating factor is whether the customer was able to plan in advance (i.e. how far in advance was the itinerary booked?).

Furthermore, the system of the present invention also effectively discourages no-shows and excessive speculative booking with respect to penalty-fares. For non-penalty fares, there is little no-show deterrence in effect in existing systems and no compelling reason to employ any special deterrence under the present invention. For penalty fares, the present system assesses a charge to the passenger at the time of reservation (e.g. an amount equal to the penalty).

In one embodiment of the present invention, this charge acts as a non-refundable deposit for travel. For example, if the reservation is flown as planned, the charge is credited towards the first segment of the itinerary. Conversely, if the reservation is not flown as planned, the charge acts as the non-refundable penalty fee.

It should be understood that under the present system, this fee would most likely represent a decrease in the up-front expenditure required by a customer by delaying the full cost of travel until departure.

The two example below demonstrate the potential of using the present system for travel using penalty fares. The first example addresses simply deterrence for a single booking. The second example illustrates the complexities of deterring speculative bookings.

### Examples for Penalties/No Show Deterrence

Event #1: Passenger books a reservation for a round trip itinerary from Minneapolis-St. Paul to Charlotte. The passenger qualifies for a round trip fare of $389. Because the fare has an associated penalty, the passenger is billed $50 as deposit for travel.

Event #2: The passenger uses the first segment of the itinerary, Minneapolis-St. Paul to Charlotte. The billing is calculated only for the used portion of the itinerary. The cost of the one-way flight from Minneapolis-St. Paul is $423. Furthermore, the $50 deposit is credited to the passenger. Accordingly, the cost generated for this segment of the travel is $423 minus $50, or $373. A revenue record is generated for the used segment using the original prorated value of $195.

Event #3: The passenger uses the second segment Charlotte returning to Minneapolis-St. Paul. Billing is calculated for the used portion of the itinerary. Thus, the cost generated for this segment of the itinerary is $389 minus $423, or a $34 credit to the passenger. Therefore, the total amount billed at usage is $339. After including the initial deposit of $50, a total fare amount of $389 is reached. Additionally, a revenue record is generated for the used segment using the original prorated value of $194.

### Example of Speculative Booking Deterrence

In this example, the passenger wants to schedule a flight from Minneapolis-St. Paul to Charlotte. However, the passenger is unsure exactly which flight to take. The Minneapolis-St. Paul to Charlotte excursion or restricted fare rate is $234 including a $50 non-refundable deposit fee. The Minneapolis-St. Paul to Charlotte unrestricted one-way fare in this example is $423.

There are at least three flights the passenger can select from when developing his or her itinerary. Using existing systems, the passenger would have two options for booking his or her itinerary. The passenger could triple-book at the unrestricted fare amount of $423. Alternatively, the passenger could triple-book the $234 penalty fare. By using the unrestricted fare, the passenger only has to buy a single ticket before departure. However, by using the penalty fare, the passenger must purchase three tickets totaling $702 within a day after booking. Thus, the passenger is faced with initial charges of either $423 or $702 ($234×3).

Furthermore, the final charges the passenger would be required to pay would either $423 (i.e. the amount of the unrestricted one-way fare) or $334 (the amount of the restricted one-way fare plus $100 in penalty deposit fees). The balance of $368 would be refunded to the passenger in the form of miscellaneous charge orders (“MCOs”).

While the passenger could realize a final savings of $89 using the penalty fares, the passenger is more likely to book the one $423 ticket rather than the three $234 tickets. In so doing, the passenger can avoid carrying the additional $279 of credit and the inconvenience of submitting two tickets for MCOs exchanges on future travel. Today's situation effectively deters this type of speculative booking and decreases the potential for revenue dilution.

Under the system of the present invention, the same passenger faced with the same situation might come to a different decision. While the proposition for using the unrestricted fare remains the same, the proposition for using the penalty fare has changed. To book three flights using the penalty fare, the passenger would only have to pay $150 up-front. Thus, the initial charges to the passenger would be $423 or $150 (i.e. the $50 deposit fee for three tickets). The final charges to the customer would be either $423 or $334 (i.e. the cost of the restricted fare ticket plus two penalty fees).

Accordingly, the system of the present invention allows the passenger to realize a final savings of $89 using the penalty fares without incurring any inconvenience for choosing the cheaper of the two alternatives. Furthermore, because there are no refunds, the passenger could get a total cost of $334 with no additional charges and no additional work. Thus, system of the present invention could reduce the deterrence for speculative booking over existing systems.

It should be noted that while the present system could expose the airline to the potential for this kind of activity, other functionality can track and report on this type of behavior. Because the system could record and maintain a record of the entire transaction, the activity of all passengers booked using the system of the present invention can be tracked and monitored to identify irregular booking practices. With a corporate account focus, corporate fare agreements can be used to set proper expectations and influence behavior (i.e. that double booking is not allowed on the corporate unpublished fare). Furthermore, the system of the present invention is capable of providing reporting to monitor agreement compliance.

In another embodiment, the bill per use functionality of the system of the present invention does not negatively affect an airline's cash float. Under the current distribution model, an airline often receives payment for travel in advance (i.e. a ticket can be paid in full to an airline prior to usage) interest free cash float. Under today's paradigm, the methods of funds transfer are straight-forward and the cash flow is predictable by sales source. One of the key concerns about bill per use is that it will adversely affect an airline's cash float.

It is important to note that many airlines today may not always receive the payment as quickly as perceived. Moreover, bill per use can improve an airline's cash float. Furthermore, there are alternative solutions that can be implemented with bill per use to manage cash float separately—maintaining today's cash flow situation while still receiving the benefits of bill per use functionality.

With respect to the amount of time it takes for airlines to receive payment, the table below illustrates the “turn time” associated with various credit card forms of payment via a travel agency and an internal airline station. Turn time is defined as the number of days after ticket issuance that it takes for an airline to receive payment from the credit card company.

| | | | |
|---|---|---|---|
| AMEX | 9.5 days | AMEX | 7 days |
| Diner's | 20.9 days | Diner's | 14 days |
| Discover | 3.72 days | Discover | 1 day |
| Master Card | 3.65 days | Master Card | 1 day |
| Visa | 3.75 days | Visa | 1 day |

The application of bill per use does not necessarily lead to a forfeit of airline cash float. A couple of options exist for applying bill per use while managing the cash float separately from the billing calculation. This cash float control can be applied at either the corporate account level or the transaction level. There are three ways to manage an airline's cash float: pure bill per use, advanced billing, or bill per use escrow accounts.

A passenger's billing amount is calculated and executed after each usage event. The airline would incur a loss of cash float loss for tickets issued well in advance of travel. There is essentially no management of cash float in this option. It is important to note that for certain types of transactions, this option can actually improve cash float.

Advanced billing would involve the pre-purchase of travel similar to today's paradigm as a transaction level deposit. A passenger could be billed for the amount of their original reservation. The passenger's “balance” would be decremented for each usage event, with adjustments occurring as necessary.

While this approach may seem to solve the cash float issue, there are several functional issues that could make this option complex. In general. this application requires more processing and systems infrastructure. Also, a key issue is introduced which revolves around the prediction of a non-event. Without a formal refund or exchange process, there is no way of distinguishing a revenue dilution situation (hidden city ticketing) from a revenue breakage (passenger is holding on to coupon to fly another day).

Similarly, a bill per use escrow account would be functionally identical to the pure bill per use. The difference would come in the settlement function. Billing calculation and execution would happen at the same time but would be applied against a direct billing account. Arrangements could be made with a corporation to use an escrow account to maintain an airline's target cash flow balance. The corporation would maintain a target balance on a daily basis, while the airline would use the escrow account as the source of its electronic funds transfers.

In another embodiment, the system of the present invention eliminates refund and exchange transactions. Two examples are illustrated below to demonstrate how the present system can eliminate refund and exchange transactions.

### Example of a Typical “Refund” Transaction Using the Method of the Present Invention

Event #1: The passenger books a reservation for a round trip itinerary from Minneapolis-St. Paul to Charlotte. The passenger qualifies for a round trip fare of $846 which actually represents the value of two one-way fares.

Event #2: The passenger uses the first segment from Minneapolis-St. Paul to Charlotte. Billing is calculated for the used portion of the itinerary or $423. A revenue record is generated for the used segment using the original coupon prorated value of $423.

Event #3: The passenger decides not to fly the second portion of the itinerary.

Event #4: At this point, the reservation is closed and no additional processing is necessary.

Under these circumstance and with existing systems, the passenger would pay $846 for the round-trip itinerary. To receive reimbursement for the unused portion, the passenger typically would seek a refund or exchange for the unused portion of the itinerary. Conversely, using the system of the present invention, the passenger would pay for travel as they go. Accordingly, only one charge of $423 dollars with no additional processing would occur.

### Example of a Typical “Exchange” Transaction Using the Method of the Present Invention

Event #1: The passenger books a reservation for a round trip itinerary from San Francisco to Philadelphia. The passenger qualifies for a round trip fare of $1,370 which represents two one-way fares.

Event #2: The passenger uses the first segment from San Francisco to Philadelphia. As a result, billing is calculated for the used portion of the itinerary which amounts to $685. Furthermore, a revenue record is generated for the used segment using the original coupon's prorated value of $685.

Event #3: While in Philadelphia, the passenger realizes that they don't need to return to San Francisco, but in fact, they need to return Los Angeles. The passenger requests a reservation change through the system of the present invention and the reservation is re-priced appropriately. The San Francisco to Philadelphia cost is $685 and the Philadelphia to Los Angeles cost is $709.

Event #4: The passenger uses the second segment of the itinerary, Philadelphia to Los Angeles. Billing is calculated for the used portion of the itinerary, for example, San Francisco to Philadelphia ($685) plus Philadelphia to Los Angeles ($709). A billing record is generated for $709 ($1,394 -$685). A revenue record is generated for the second segment ($709).

With existing systems, the passenger would pay $1,370 for a round trip itinerary from San Francisco to Philadelphia. Once in Philadelphia, if the passenger decides that instead of returning to San Francisco that he or she will instead go to Los Angeles, the return coupon of Philadelphia to San Francisco acts as a form of payment for the new second segment of the itinerary. An exchange transaction is required to convert the second coupon with an amount due of $24.

On the other hand, under the system of the present invention, because the sales transaction is merged with the usage transaction, the passenger would pay $1,394 for the actual itinerary flown without any problems. Additionally, the billing can be accompanied by a notice explaining the charges of $685 for the San Francisco to Philadelphia segment plus $709 for the Philadelphia to Los Angeles segment.

In another embodiment, the system of the present invention also tightens the airline's control over revenue by expanding the emphasis from the sale event to the usage event. Typically, many airlines lose control over revenue in the form of “throw away” usage. For example, approximately one percent of USAir™ travel coupons go unused for the life of the ticket. While a portion of these unused coupons represent revenue breakage (i.e. the airline gets money for nothing), another portion represents revenue dilution.

This revenue dilution can be grouped into two “throw away” usage groups: (1) hidden city ticketing and (2) the purchase of a round trip fare to fly one-way. Listed below are actual examples of each type of behavior. It should be noted that these examples only illustrate the potential application for the present invention. Airlines will have to consider whether they wish to take advantage of this advanced functionality.

### Example of Hidden City Ticketing

Event #1: The passenger books a reservation for a one-way itinerary flying from San Francisco to Baltimore stopping over in Philadelphia. The one-way fare for the trip is $472. The passenger intends to go to Philadelphia and not to Baltimore but wants to avoid the San Francisco to Philadelphia fare amount of $685.

Event #2: The passenger uses the first segment of the itinerary from San Francisco to Philadelphia. Billing is calculated for the used portion of the itinerary, that is, from San Francisco to Philadelphia at a rate of $685. A revenue record is generated for the used segment using the coupon revenue prorated value of $400.

Event #3: With the connection flight unused, the reservation is closed. The billing amount of $685 does not equal the revenue amount of $400. A revenue adjustment record is created for the difference which is $285. With the revenue amount equaling the billing amount, the reservation is archived.

Today, a passenger can pay $472 for the San Francisco to Baltimore segment, fly the San Francisco to Philadelphia segment, and discard the Philadelphia to Baltimore coupon. The airline in this case would lose $213 from straight revenue dilution and forfeits a potential confirmed booking on the Philadelphia to Baltimore flight. In contrast, under the system of the present invention, a passenger is billed $685 for the actual itinerary flown. The billing is accompanied by a notice explaining the charges.

### Example of Impact on Hidden City Ticketing

Event #1: The passenger books a reservation for a one-way itinerary flying from San Francisco to Baltimore stopping over in Philadelphia. The one-way fare for the trip is $472. The passenger intends to go to Philadelphia and not to Baltimore but wants to avoid the San Francisco to Philadelphia fare amount of $685.

Event #2: The passenger uses the first segment of the itinerary from San Francisco to Philadelphia. Billing is calculated for the used portion of the itinerary, that is, from San Francisco to Philadelphia at a rate of $685. A revenue record is generated for the used segment using the coupon revenue prorated value of $400.

Event #3: With the connection flight unused, the reservation is closed. The billing amount of $685 does not equal the revenue amount of $400. A revenue adjustment record is created for the difference which is $285. With the revenue amount equaling the billing amount, the reservation is archived.

### Example of Impact on Round Trip Booking/One-Way Usage

Event #1: The passenger books an reservation for a round trip itinerary from Minneapolis-St. Paul to Charlotte and qualifies for a round trip fare of $234. The passenger intends to fly one way but wants to avoid the one way fare of $423 for a one-way flight between Minneapolis-St. Paul and Charlotte.

Event #2: The passenger uses the first segment of the itinerary of Minneapolis-St. Paul to Charlotte. Billing is calculated for the used portion of the itinerary, i.e. the Minneapolis-St. Paul to Charlotte one-way fare of $423. A revenue record is generated for the used segment using the coupon's prorated value of $117.

Event #3: The reservation is closed when the return trip does not occur within a set period of time. At this point, the billing amount of $423 does not equal the revenue amount of $117. A revenue adjustment record is created for the difference of $306. With the revenue amount equaling the billing amount, the reservation is archived.

Under existing system, a passenger will pay a fare of $234, fly the Minneapolis-St. Paul to Charlotte segment, and discard the return portion of the itinerary, i.e. Charlotte to Minneapolis-St. Paul. Conversely, with the system of the present invention, a passenger is billed $423 for the actual itinerary flown. Furthermore, the billing is accompanied by a notice explaining the charges.

Furthermore, with existing systems, a passenger has the potential to avoid paying the $50 change fee associated with a restricted fare by avoiding the check-in counter and having their changes made at the gate. Savvy travelers know that not only do gate personnel know less about fare restrictions and ticketing rules, but also they have other priorities and are less likely enforce them when pressed for time. Typically, the non-payment of these fees is around $4.8 million a month.

There are other problems associated with change fees. For example, some passengers might use fares on improper flights, i.e. an off-peak ticket accepted on a peak flight. Similarly, a passenger may switch their coupon after receiving a boarding pass.

Perhaps the most significant cost from this activity is not the actual change fee revenue but the revenue dilution caused by passengers choosing cheap restricted fares over higher unrestricted fares because an expectation has been created that the rules will not be enforced. In one embodiment, the present invention is capable of enforcing 100% collection of these change fees. Provided below are examples of how the present invention would enforce collection of change fees.

### Example of Enforcement of Change Fees

Event #1: The passenger books a reservation for a round trip itinerary from Minneapolis-St. Paul to Charlotte. The passenger qualifies for a round trip fare of $234. There is a $0 penalty/change fee associated with this fare.

Event #2: The passenger flies the Minneapolis-St. Paul to Charlotte outbound segment but modifies the return segment using a system as described in the present invention. In so doing, the passenger keeps the origin and destination but moves the departure date back one day. The airline reservation technologies system of the present invention can recalculate the fare and determine that the passenger still qualifies for the same fare. The passenger is charged a $50 change fee for the modification of the original reservation.

Today, a passenger could arrive at the airport gate and, depending on the gate agent, potentially board with no application of the $50 change fee. With the system of the present invention, the sale transaction is combined with the usage transaction. Accordingly, a passenger is automatically billed a $50 change fee when the passenger modifies the itinerary. As stated earlier, 4% of transactions qualify for a change fee but go uncollected. This amounts to approximately $4.8 million per month.

In addition to the examples provided above, further examples of the bill per use functionality are shown in Figures In yet another embodiment, the system of the present invention addresses the issue of passenger billing. As discussed above, the present system employs a “pay-as-you-go” philosophy. Thus, the itinerary is priced before each billing based on the segments that have been used. However, executing the billing as it is calculated has the potential to create customer confusion for complex itineraries. A balance must be maintained between customer satisfaction and timeliness of cash inflow. If a passenger has a four segment itinerary spread over four days, the billing issue becomes whether the system should bill that passenger four times, or wait until the expected end of the itinerary and perform a single billing.

The system of the present invention offers three primary options to balance the inflow of payments with the complexity to the customer: (a) pure bill-as-you-go; (b) calculated billing points; and (c) billing wrap-up.

The pure bill-as-you-go feature of the present invention allows the airline to bill each reservation at the end of day based on the itinerary used. It should be noted that domestic connection flights (except for red-eye flights) will be completed on the same day and not result in multiple billings. The positive aspects of the bill-as-you-go feature is that it offers the airlines a chance at timely billing. On the other hand, because multiple billings may appear on the statement for one itinerary, it is likely that the customer will not be satisfied with this approach.

The calculated billing approach allows logical billing points to be established when a reservation is created. Time parameters can be used to consolidate billings and moderate billing frequency to the customer. For example, if there is less than a two day time lapse between segments, the system of the present invention can consolidate the billing. The positive aspects of this feature is that there is moderate billing potential, that is, there will be some delay on billing. Similarly, there is likely to be moderate customer satisfaction because there is still a chance of multiple billings for one itinerary.

With the billing wrap-up feature of the present system, a reservation will be billed a set number of days after the last scheduled segment. In this instance, there will be good customer satisfaction as there is likely to be only one billing per flight. On the other hand, billing will be untimely because airlines typically will have to wait until entire reservation is flown to receive payment.

It should be understood that the options for managing airline cash float discussed above can be applied independent to the billing statements to the customer.

Moreover, the system of the present invention will need to pass accurate segment values to an airline's marketing and revenue accounting departments. This approach seems logical, but when considered in light of the methods of the present invention, the point needs clarification. For billing, the present system uses the prorated value of the coupon based on the used portion of the itinerary. Similarly, for revenue, the system of the present invention passes the best-guess value of the coupon based on the prorated value of the original itinerary. The difference between the billed amount and the revenue amount will be held in a WIP Account database. When the reservation is closed or modified, a revenue adjustment record is generated to sync the billing and revenue amounts.

For example, a passenger making a reservation using a system of the present invention may originally qualify for a round trip fare of $234. When the first segment is used, a revenue record will be generated for $117. At the time of usage, $117 is the “best guess” or presumed value of the segment.

Alternatively, when an intermediate billing is performed, the itinerary is re-priced based on the used segments. For example, a single segment of the above-mentioned round trip itinerary might be priced and prorated at a value of $423. The difference between the amount billed, and the amount sent to revenue for any given segment is recorded in the WIP account database. Thus, when a reservation is closed, adjustments will be sent to revenue to clear the WIP account database and sync the dollars sent to revenue to the dollars billed.

Furthermore, today's airport processing is sophisticated enough to handle two types of product: the traditional paper ticket and the electronic ticket. The system of the present invention is capable of handling a third product to the airport. For example, the system of the present invention will be capable of handling transactions through a series of self-service kiosks. For example, a passenger boarding a plane can identify the partial usage of a reservation by swiping a card through a card reader located at the gate. Service agents would have to be trained on a new series of airport procedures to accommodate the passengers making use of such a system.

The introduction of self-service kiosks presents several issues for airlines. For example, airlines should address whether the airport operations can absorb a third type of transaction. Similarly, does airport processing have to change at all? Can the system of the present invention provide its benefits using existing airport processing structure? Furthermore, can the system of the present invention exploit the existing electronic ticket infrastructure and personnel training deployed at airports today? The system of the present invention preferably has two sets of information to achieve a successful result: (1) a means to authorize passenger boarding, and (2) an accurate usage feed to show what portion of an itinerary has been used. Initial investigation of the electronic ticketing infrastructure and procedures reveal that existing electronic ticket database could function as the primary feed into the system of the present invention. The system of the present invention could utilize an electronic ticket transaction to mirror normal electronic ticketing functionality at the airport while capturing some of the benefits of the present invention.

At the time a reservation is created, the system of the present invention would generate a PNR record, an electronic ticket transaction, and a Master Reservation Database entry containing a marriage of electronic ticket and PNR information. In one embodiment of the present invention, the Master Reservation Database would be updated regularly with usage information from the airline's electronic ticket database. Reservation modifications would be able to be handled through either the system of the present invention or service agents at the airport with minimal training on how to handle the transaction using the present system. The electronic ticket reissues from the system of the present invention could also be handled through either the present invention or using service agents at the airport with minimal training on how to handle a transaction using the present invention.

While the invention has been particularly shown and described with reference to preferred embodiments thereof, it will be understood by those skilled in the art that various other changes in the form and details may be made therein without departing form the spirit and scope of the invention.

We claim:

1. A method for reducing the costs and enhancing revenue controls associated with airline travel distribution, wherein the need for transactional verification and reconciliation is eliminated, the method comprising:
combining a sales transaction and a usage transaction into one centralized transaction, wherein each sales transaction represents a usage transaction; and
eliminating the advanced issuance of an accountable and specific travel authorization.

2. The method of claim 1, wherein the centralized transaction provides the airline with an ability to control the price of the airline travel distribution product at the time the product is used.

3. The method of claim 1, wherein the accountable and specific travel authorization is an airline ticket.

4. The method of claim 1, wherein the accountable and specific travel authorization is an electronic ticket.

5. The method of claim 2, wherein the airline's ability to control the price of the airline travel distribution product includes automatically collecting penalty fees.

6. The method of claim 2, wherein the airline's ability to control the price of the airline travel distribution product includes automatically verifying fare qualifications at usage.

7. A system for reducing the costs and enhancing revenue control associated with airline travel distribution, wherein the need for transactional verification and reconciliation is eliminated, the system comprising a bill per use module that combines each sales transaction with a corresponding usage transaction into one centralized transaction, wherein each sales transaction represents a usage transaction, wherein the bill per use module further eliminates the advanced issuance of an accountable and specific travel authorization.

8. The system of claim 7, wherein the bill per use module provides the airline with an ability to control the price of the airline travel distribution product at the time the product is used.

9. The method of claim 7, wherein the accountable and specific travel authorization is an airline ticket.

10. The method of claim 7, wherein the accountable and specific travel authorization is an electronic ticket.

11. The method of claim 8, wherein the bill per use module provides the airline with an ability to control the price of the airline travel distribution product at the time the product is used by automatically collecting penalty fees.

12. The method of claim 8, wherein the bill per use module provides the airline with an ability to control the price of the airline travel distribution product at the time the product is used by automatically verifying fare qualifications at usage.

13. A computer storage medium readable by a computing system and encoding a computer program of instructions for executing a computer process for reducing the costs and enhancing revenue controls associated with airline travel distribution, said computer process comprising the steps of:
combining a sales transaction and a usage transaction into one centralized transaction, wherein each sales transaction represents a usage transaction; and
eliminating the advanced issuance of an accountable and specific travel authorization.
